(19) United States
(12) Patent Application Publication
(10) Pub. No.: US 2024/0378648 A1
(43) Pub. Date: Nov. 14, 2024

(54) SYSTEMS AND METHODS FOR AN INCENTIVIZED NETWORKING ECOSYSTEM

(71) Applicant: VeriFi Labs, Inc., Augusta, GA (US)

(72) Inventors: Ian Holbrook, Las Vegas, NV (US); Dale Lakes, Augusta, GA (US)

(21) Appl. No.: 18/599,660

(22) Filed: Mar. 8, 2024

Related U.S. Application Data
(63) Continuation-in-part of application No. PCT/US23/77724, filed on Oct. 25, 2023.
(60) Provisional application No. 63/381,992, filed on Nov. 2, 2022.

(51) Int. Cl. G06Q 30/0282; G06Q 30/0217; H04W 76/10

(52) U.S. Cl. CPC G06Q 30/0282; G06Q 30/0217; H04W 76/10

(57) ABSTRACT

A system including one or more memories storing computer executable instructions and one or more processors. When executing the computer executable instructions, the one or more processors are configured to obtain user location data from a first user device of a first user and obtain owner data of an owner business. The system further includes a ratings interface permitting the first user to assign a user rating associated with the business, services and/or merchandise, and ratings verification system which assigns varying measures of weight, credibility, or usefulness to the user rating in accordance with the first user's location data and travel data.

### BACKGROUND

The present disclosure relates to networking ecosystems. More specifically, the present disclosure relates to systems and methods for providing and using an incentivized and decentralized ecosystem.

Nearly 40 percent of the global population does not have reliable internet access. Accordingly, these people cannot access and participate in various digital communities. Additionally, due to the lack of internet accessibility, the prevalence of web3 decentralized technologies is significantly limited.

### SUMMARY

In one exemplary embodiment, there is provided an incentivized system. The system includes one or more memories storing computer executable instructions and one or more processors. When executing the computer executable instructions, the one or more processors are configured to obtain user location data and travel data from a first user device of a first user, obtain owner data of an owner business associated with a wireless access point (WAP), prompt the first user to input WAP data associated with the WAP, and verify the WAP. The one or more processors are further configured to generate a WAP verification status, generate a WAP database based at least in part on the owner data, the WAP data, and the WAP verification status, and automatically connect subsequent user devices of subsequent users to the WAP.

In another exemplary embodiment, there is provided a computer-implemented method. The method includes the steps of obtaining user location data and travel data from a first user device of a first user, obtaining owner data of an owner business associated with a wireless access point (WAP), prompting the first user to input WAP data associated with the WAP, and verifying the WAP. The method further includes the steps of generating a WAP verification status, generating a WAP database based at least in part on the owner data, the WAP data, and the WAP verification status, and automatically connecting subsequent user devices of subsequent users to the WAP.

In another exemplary embodiment, there is provided a non-transitory computer-readable medium containing computer executable instructions that, when executed by one or more processors, cause the processors to perform a method. The method includes the steps of obtaining user location data and travel data from a first user device of a first user, obtaining owner data of an owner business associated with a wireless access point (WAP), prompting the first user to input WAP data associated with the WAP, and verifying the WAP. The method also includes the steps of generating a WAP verification status, generating a WAP database based at least in part on the owner data, the WAP data, and the WAP verification status, and automatically connecting subsequent user devices of subsequent users to the WAP.

### BRIEF DESCRIPTION OF THE DRAWINGS

The embodiments illustrated herein are not limited to the precise arrangements, sequential steps, and dimensions shown. Like numerals indicate like elements throughout the drawings. In the drawings:

FIG. 1 illustrates a schematic view of a system for providing an incentivized web3 ecosystem;

FIG. 2 illustrates a schematic view of the ecosystem server;

FIG. 3 illustrates a flowchart of a method for connecting users to a network;

FIG. 4 illustrates a flowchart of a method for mapping user locations and network access points on an interactive map;

FIG. 5 illustrates a flowchart of a method for facilitating communication between users based upon proximity;

FIG. 6 illustrates a flowchart of a method for facilitating communication between users based upon user characteristics;

FIG. 7 illustrates a schematic view of an interactive map displaying wireless access points;

FIG. 8 illustrates a schematic view of a streamlined user interface for viewing business information associated with one or more wireless access points;

FIG. 9 illustrates a flowchart of a method for generating the user interface of FIG. 8;

FIG. 10 illustrates a flowchart of a method for verifying a wireless access point;

FIG. 11 illustrates a schematic view of an infinite caching system wherein certain wireless access points are grouped together for subsequent caching onto a user device; and

FIG. 12 illustrates a flowchart of a method for infinitely caching wireless access points.

FIG. 13 illustrates a schematic view of another embodiment of the ecosystem server which further includes a ratings system.

FIG. 14 illustrates a schematic view of a ratings user interface for viewing rating information related to a business.

FIG. 15 illustrates a schematic view of a display interface for the ratings system.

FIG. 16 illustrates a flowchart of a ratings verification and display method.

### DETAILED DESCRIPTION

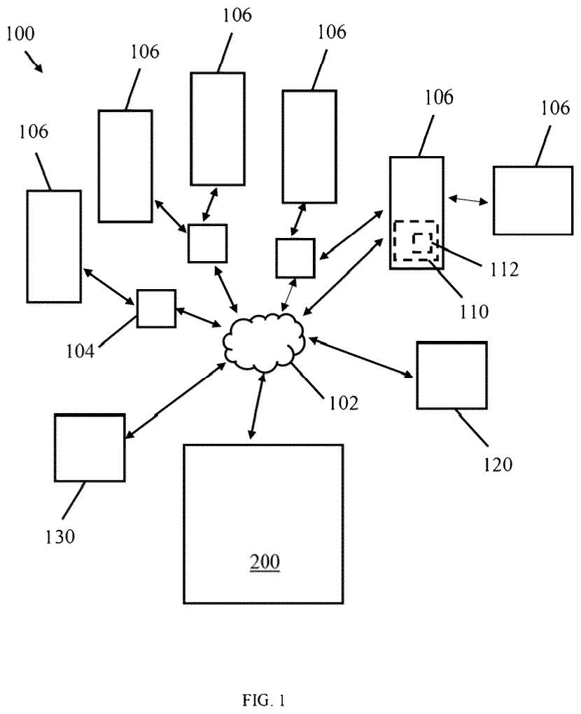

FIG. 1 illustrates an example of a system 100 for providing an ecosystem, such as a web3 ecosystem, that includes a crowdsourced network, an interactive map, and/or one or more communication systems. The system 100 generally comprises a network 102, one or more access points 104 for accessing the network 102, user devices 106, and an ecosystem server 200 connected to the devices 106 via the network 102. The system 100 may comprise an incentivized and gamified application 110 which is downloadable onto one or more devices 106, as shown in phantom in FIG. 1. It is conceivable that in other embodiments, the system 100 may include different or additional elements from what is illustrated in FIG. 1.

The system 100 functions as a bridge between the real world and the metaverse. The system 100 provides internet access and facilitates communication between users based upon unique blockchain identifiers, such as the ownership of a particular group of NFTs, via an interactive map 112 and one or more communication systems. The system 100 connects users to free crowd-sourced network access points 104. The system 100 also facilitates communication within and outside of its ecosystem. The system 100 rewards user contributions and validations through economic in-ecosystem incentives and achievement-based gamification. The system 100 provides a rewarding user experience with effectively zero entry costs for its users. For example, users of the system 100 can earn economic prizes, e.g., tokens, and achievements by adding new, connecting to, and verifying network access points 104. Users can also be awarded for fulfilling bounties, completing goals, and earning achievements. The system 100 can also provide a marketplace where users can buy, sell, and trade collectibles, such as Non-Fungible Tokens (NFTs) with other users. The system 100 can also generate access point data from one or more owner databases 130, which is associated with one or more owners such as commercial businesses, and a streamlined display within the application 110 to notify users of various information and incentives on behalf of the owners of the access points 104.

The system 100 also comprises a blockchain 120. The ecosystem server 200 may be connected to and retrieve data relating to the users who use the blockchain 120. Any type of blockchain may be utilized. The system 100 may implement a blockchain ledger, manager, wallet, or like technology. The system 100 may connect to a blockchain of a third party. Any number of existing blockchain providers may be utilized, for example Ethereum, Bitcoin, Dfinity, or Blockphase.

The network 102 can be any type of communications network, such as a local area network (LAN), wide area network (WAN), a public network such as the internet, and/or some combination thereof. In general, communication between the various devices and systems may occur via any desired network interface using any type of wireless connection, using a variety of communication protocols (for example UDP, TCP/IP, HTTP, S1v1TP, FTP), encodings or formats (for example HTML, JSON, XML), or protection schemes (for example VPN, secure HTTP, SSL).

The system 100 may further comprise one or more Wi-Fi® or wireless access points (WAPs) 104, which can be identified, added, and verified by users. The WAPs 104 may only be WAPs associated with places of business, and thus may not be associated with homes or apartments. In more details below, the ecosystem server 200 identifies and verifies certain characteristics of the WAPs 104. Each access point 104 may or may not be associated with an owner database 130 which is in communication the ecosystem server 200.

The system 100 may further comprise one or more owner databases 130 associated with the one or more access points 104. Each owner database 130 can be associated with only one or multiple access points 104. Each owner database 130 may store data associated with the business, such as hours of operation, incentives like discounts or special deals, events, and the like. The ecosystem server 200 can be connected to each owner database 130 via the network 102.

The user devices 106 may connect to the network 102. For instance, the user devices 106 may connect to the network 102 through the one or more WAPs 104. Additionally or alternatively, the user devices 106 may connect to network 102 via their service provider or an unlisted WAP. The devices 106 can be associated with one or more users and/or with one another. A single user may have two or more devices 106. Each device 106 can be connected to the system 200 via one or more WAPs 104 and the network 102. Alternatively, one device 106 may not be directly connected to the network 102 and may instead be connected to another device 106 which is connected to the network 102.

Each user may have one or more devices 106 that may be stationary, portable, and/or wearable. The devices 106 can be in the form of smart devices. The devices 106 may be in the form of a computer, a smartphone, a tablet, a navigation system, a handheld GPS system, user equipment (UE), a portable gaming device, a media user head-mounted display (HMD), a virtual, augmented, and/or mixed reality device, such as a headset or glasses, smart glasses, smart clothes, smart shoes, data gathering implants, and/or or other suitable data gathering electronic devices. The user devices 106 may or may not be identical to one another. By way of example only, one user may have a smartphone 106 and a wearable device 106, such as a smartwatch, that is connected to the smartphone 106 and/or the network 102. It should be appreciated that the user may only have a smartphone 106, have both smartphone 106 and wearable device(s) 106, or just a wearable device(s) 106 only.

Each device 106 may include input/output devices, e.g., a display screen, lights, and speakers, a local data storage, one or more sensors, one or more applications, one or more application programming interfaces (APIs), and/or a notification module. Each device 106 may further include the application 110 of the ecosystem server 200. Each device 106 can display the interactive map 112 generated by the ecosystem server 200. The devices 106 may also include other components known to those skilled in the art. Therein, the devices 106 may include any desired hardware and/or software for generating user data.

The one or more sensors, integrated within the device 106, may include a location sensor, in the form of a timekeeping device, a positioning device, a speed sensor, an accelerometer, a gyroscope, an altimeter, a pedometer, a heart rate sensor, and/or a camera. For instance, the positioning device may monitor the position of the smartphone 106 and/or wearable device 106. However, the one or more sensors may include other and/or additional sensors as appreciated by the skilled artisan.

The positioning device can be any device or circuitry; for example, the positioning device may comprise a GPS system, a Galileo positioning system, a Global Navigation satellite system (GLONASS), a BeiDou Satellite Navigation, or a Positioning system. As the user moves around with the device 106 in the physical world, the positioning device can track the position of the user and provide user location data to the ecosystem server 200.

The application 110 may monitor and collect user data, WAP data, access point owner or business data, and/or blockchain data. The application 110 may comprise part of the device's 106 operating system and/or additional software installed by the user. The application 110 may or may not include a data collection module. The application 110 may or may not retrieve data from other systems and/or applications on a device 106.

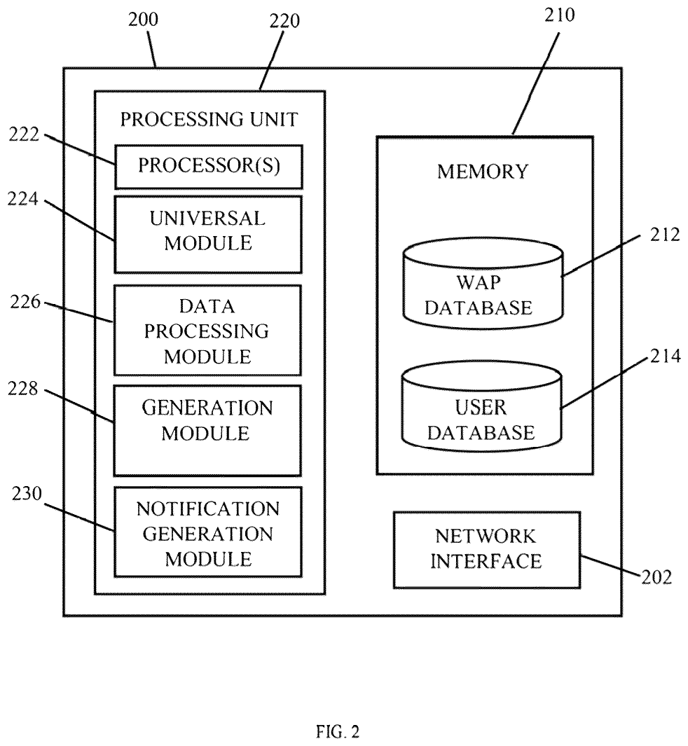

Referring now to FIG. 2, the ecosystem server 200 is configured for intaking and processing data from the devices 106, the WAPs 104, the blockchain 120, and/or the access point owner databases 130. The ecosystem server 200 may include a network interface 202, a computer-readable storage media 210, such as a memory, and a processing unit 220. The ecosystem server 200 may additionally include APIs for interacting with the devices 106, the WAPs 104, the blockchain 120, and/or the owner databases 130. In some embodiments, the ecosystem server 200 may contain different or additional elements, and the various functions thereof may be distributed among its various elements in a different manner than described herein.

The network interface 202 establishes communication between the ecosystem server 200 and the network 102. The network interface 202 can include any suitable components for interfacing with one or more networks, including, for example, transmitters, receivers, ports, controllers, antennas, or other suitable components.

The memory 210 stores WAP data, user data which may be inputted by the user or sensed by the user's device 106, map data, and blockchain data associated with the users. The memory 210 may generally include any suitable computer readable media, transitory or non-transitory, for storing instructions.

In some embodiments, the memory 210 may include a WAP database 212 and a user database 214. The databases 212, 214 may be part of the ecosystem server 200 or separate from the ecosystem server 200 and accordingly be remotely accessed through the network 102. The WAP database 212 may store information associated with one or more WAPs 104, including WAP location, download and upload speed, range, security information, and/or associated interior or exterior spaces. The WAP database 212 may also store access point owner data, or business data associated with one or more businesses associated with one or more WAPs 104, retrieved from the owner databases 130 and/or the user devices 106. The user database 214 may store information associated with the past and present users. In some embodiments, the memory 210 may include a single database which stores all necessary data.

The processing unit 220 generally includes one or more processors 222 for executing computer-readable instructions. One or more of the processors can be an AI processor 222. The processing unit 220 may further include a universal module 224, a user data processing module 226, a generation module 228 for generating the GUI and the map 112 displayed on the devices 106, communication platforms, and digital elements, e.g., avatars, tokens, NFTs, etc., and a notification generation module 230. The processing unit 220 generates the interactive WAP map 112, which maps the digital onto the physical. The processing unit 220 may also generate a first communication system for allowing users to communicate with one another in the real world and/or digital world, and a second communication system for allowing users to meet up with one another in the real world and/or digital world.

The one or more processors 222 may perform the various functions of the processing unit 220 described herein. The AI processor 222 may comprise an artificial neural network using a machine learning algorithm. The AI processor 222 may train its artificial neural network using a training module. The training module may be included in the ecosystem server 200 or may be included in an external device. The training module can be implemented in hardware, software or a combination of hardware and software. The training module may be stored in the memory 210.

The universal module 224 hosts and generates content for the users. The universal module may conduct a user verification process, a WAP verification process, a blockchain verification process, update the map, and establish and facilitate communication between users. The universal module 224 may also govern device connectivity and the security thereof. It is noted that the user data processing module 226, the generation module 228, and/or the notification generation module 230 can be a part of or separate from the universal module 224.

The user data processing module 226 may receive user data associated with various characteristics of the users, association data, i.e., blockchain data associated with the users, wallet data, NFT data, group status, past, present, and projected future location data, and/or user velocity. Therein, the user data processing module 226 may identify user inputted preferences, such as privacy requests or communication requests, determine whether a given user is alone or with a group, and determine whether the user is stationary, walking, or traveling by a mode of transportation.

The generation module 228 is configured to generate the WAP and user databases 212, 214, the WAP map 112, and various user interfaces and overlays to enable the users to interact with other users and access point owners. The generation module 228 may generate communication prompts between users based on blockchain data. The generation module 228 may also generate one or more virtual or digital elements. Such virtual elements can be viewed as part of the map 112, an AR, and/or a VR experience. The virtual element generated can be an avatar of the user, a profile, a digital object which may or may not be associated with the user's avatar, a coupon, a generated and real time user status, a token, an NFT group or category, or a media display.

The virtual element can also be an NFT. The NFT may be an image, a video, a 2D and/or 3D digital object. The generation module 228 may automatically generate and mint the NFT depending upon the user data and/or display data. For instance, the generation module 228 may automatically create the NFT based on the actions of the user and/or access point owner data. Additionally, for instance, the generation module 228 may automatically create a user specific NFT based on the user's inputted preferences, such as preferential selections of various options. The NFT can be used in any interface, marketplace, or metaverse. Additionally or alternatively, the user may identify a preexisting NFT which is verified by the processing unit 220. Additionally, for instance, instead of stamps on a coupon card, the user may be awarded NFT stickers on a digital coupon card which can be conglomerated into a special NFT or another award.

The notification generation module 230 is configured to generate one or more notifications for each user. The notification generation module 230 may generate one or more virtual, audio, and/or, visual notifications. The notification generation module 230 may generate a notification in real time. The notification generation module 230 may generate a notification depending upon user data and/or the user's sensed location or activity. A notification may include a prompt for further action, such as communicating with another user who belongs to the same NFT community. The notification may also be a link to an associated webpage or an element generated by the processing unit 220.

Referring collectively to FIGS. 1-10, the processing unit 220 can perform various functions to establish an ecosystem for facilitating the interaction and communication between users and access point owners. The processing unit 220 allows users to use the ecosystem server 200 to easily navigate to WAPs, connect to WAPs, communicate with members in their community, and interact with various businesses.

In operation, the processing unit 220 can initially receive user data inputted by the users. Such user data can include a user's residency, preferred mode of transportation, crypto wallet, interest groups such as an ownership of various NFTs, a user's profile picture which may be in the form of an NFT owned by the user, and a user's communication preferences. The processing unit 220 may also receive user data which is sensed by the various sensors of the user's device(s) 106, such as user location data and user travel data. From the user data, the processing unit 220 may determine a user location, a heading, a travel plan or schedule, a state of travel such as if the user is stationary, walking, biking, or traveling at higher speeds in a vehicle or train.

The processing unit 220 can also obtain owner data from a third party database which may or may not be associated with the access point owner, directly from the access point owner, and/or the users inputting the owner data. The owner data can indicate WAP data, such as connection speed, security, etc., a location, dimensions and boundaries of the buildings which house the WAPs, and information concerning the kind and operation of the business, such as the hours of operation, a menu, an incentivized award system, and/or any specific incentives such as coupons, awards, or deals.

To obtain and maintain a database of WAPs, the processing unit 220 can prompt one or more users to input WAP data, such as the location, name, and/or password of the WAP if required. Additionally or alternatively, the processing unit may obtain any requisite WAP data from the access point owner. The processing unit 220 can generate and maintain the WAP database, adding thereto upon identifying WAPs from third party databases, WAP data provided by access point owners, and/or WAP data provided by users and/or sensed by users connecting to and interacting with the WAPs. Furthermore, the processing unit 220 may intake, store, validate, and automatically connect user devices 106 to WAPs 104.

Upon generating the WAP database, the generation module 228 of the processing unit 220 may generate the interactive map 112. The map 112 may display the location of the WAPs 104, the location of the users, and various other geographical, building, and roadway information. As discussed in more detail below, the generation module 228 may additionally generate business interfaces, such as graphical user interfaces, to easily allow users to see and review various businesses, make orders, apply the various incentives such as discounts, and interact with other users at a particular business location.

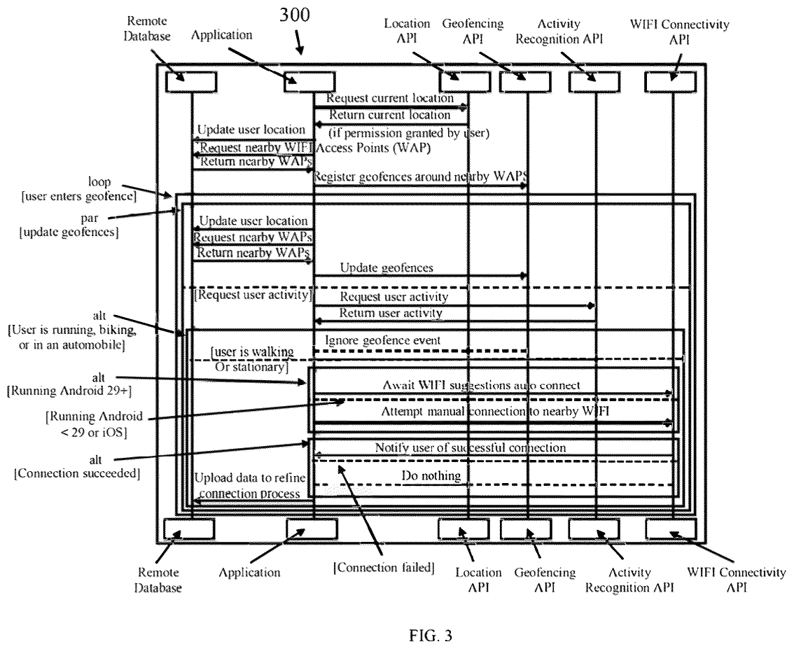

FIG. 3 illustrates a flowchart of an auto connectivity method 300 for connecting user devices 106 to the network 102 via one or more access points 104, such as WAPs 104. The processing unit 220 may automatically connect user devices 106 to the WAPs 104. The processing unit 220 first requests the current location of the user, via the sensors of the user device(s) 106. The processing unit 220 may utilize a location API. The current location of the user is returned to the application 110. Subsequently, the current location of the user is sent from the application 110 and updated to the memory 210. The application 110 can continue by requesting from the memory 210 various WAPs 104, which are geographically nearby the present WAP 104. If found, the memory 210 will return nearby WAPs 104. The application 110 next registers and updates geofences around nearby WAPs 104, for example by utilizing a geofencing API.

When a user enters a known geofence within the application 110, the processing unit 220 will update the geofence and this will send the user's current location back to the memory 210. The application 110 will then continue to request nearby WAPs 104. The memory 210 returns nearby WAPs 104, and the application 110 then updates the geofences via the geofence API. In parallel, the application 110 simultaneously requests user activity through an activity recognition API. If the activity recognition API returns the user's travel state to the application 110 that the user is running, biking, or in an automobile, then the application 110 will ignore the geofence event between itself and the geofencing API. If the activity recognition API returns that the user is in a travel state of walking or stationary to the application 110, there are a few different responses based upon what software the user is utilizing. If the user is running Android 29+, the application will await WAP suggestions to auto connect to a Wi-Fi® or WAP connectivity API. If the user is utilizing less than Android 29 or iOS, the application will attempt manual connection to nearby WAPs 104 with the WAP connectivity API. A prompt will be pinged to the user device 106 and the user can easily confirm the desire to connect to the WAP 104, and thereafter the user device 106 will be automatically connected to the WAP 104.

If the connection succeeds, the WAP connectivity API will return a success notification to the application 110, and then the application 110 will notify the user of a successful connection. If the connection fails, the user device 106 will not be connected to the WAP 104, and the processing system 220 will search for any surrounding WAPs 104 to initiate the automatic connection protocol. With either response from the WAP connectivity API to the application 110, the application 110 will update the result to the memory 210 to refine the connection process and prune any inactive WAPs 104.

The connectivity method 300 described herein reduces user involvement and energy consumption of the user device 106. The user does not need to actively search or log on to a nearby WAP 104 since the processing unit 220 will automatically connect the user's device 106 to the network 102. Furthermore, the connection to WAPs 104 passively occurs based upon the processing unit's 220 determination that the user is within a certain proximity of a validated WAP 104 and in an appropriate travel state. Therein, no energy or computational power is spent attempting to connect to WAPs 104 if the user is not at the appropriate location and in the appropriate travel state.

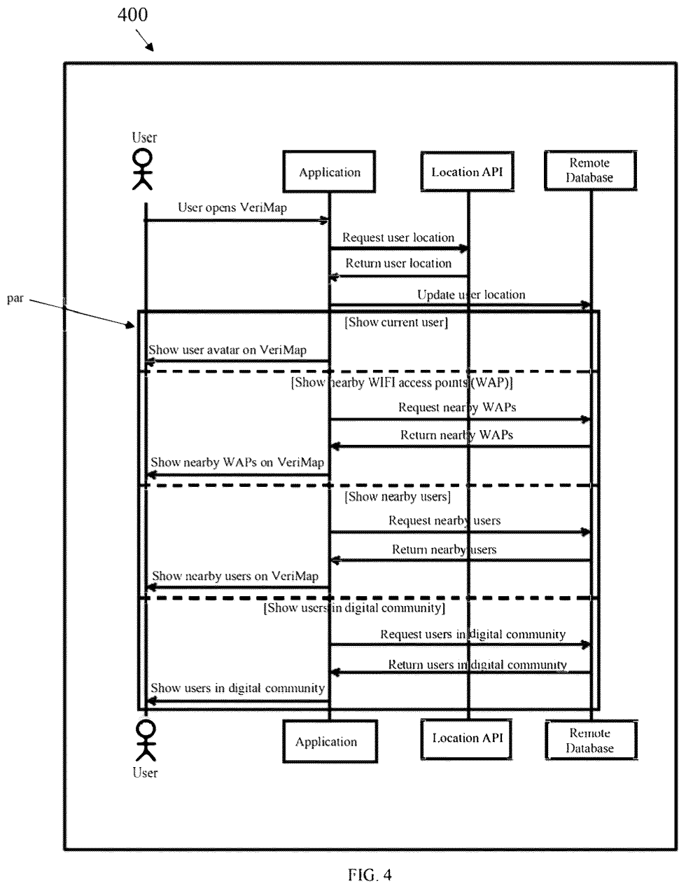

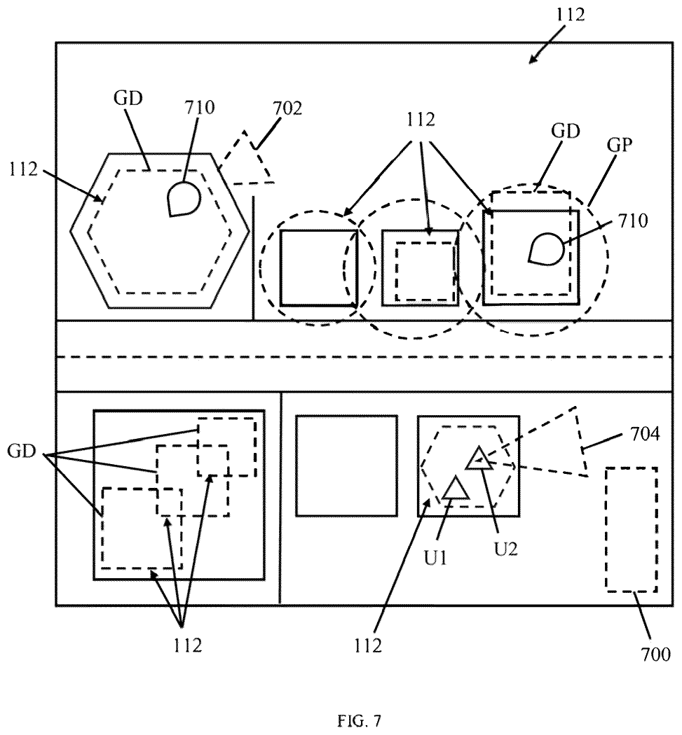

FIG. 4 illustrates a flowchart of a mapping method 400 for connecting users to WAPs 104 and also connecting the users to each other. The interactive map 112 of the system 100 may be displayed on the user's device(s) 106. The map 112 is the primary interface between users and the ecosystem. As shown in FIG. 7, in the map 112, users can see WAPs 104, including location and characteristics thereof, other users U1, U2 such as those who belong to the same or similar digital communities or groups associated with blockchain data, their own digital avatar and/or profile, and/or a UI or portal streamlining access point owner information. The map 112 may also display communication and/or meetup options among users.

In operation, a user opens the application 110. The application 110 requests user location from a location API. The location API updates the user location to the ecosystem server 200, e.g., memory 210. The location API returns user location to the application 110 and the application 110 displays current user location on the map 112. In parallel, the application 110 may display: the user's avatar U1, nearby users and their avatars U2, users in the same digital community or group U1, U2, and WAPs 104. To display other users on the map 112, the application 110 may submit a request to the memory 210, which returns nearby users within the bounds of the map 112 displayed on the screen of the device 106. To display other users in the same digital community or group, the application 110 may submit a request to the memory 210, which returns and displays such users on the map 112. To display WAPs 104, the application 110 may submit a request to the memory 210, which returns WAPs 104 within the bounds of the map 112 displayed on the screen of the device 106. As the user adjusts the map 112, e.g., panning, zooming, etc., the aforementioned avatars and WAPs 104 will dynamically change to show avatars and WAPs 104 that exist within the new bounds of the map 112.

The processing unit 220 may generate one or more communication systems 700, 702 for establishing communication among users. For example, the processing unit 220 may comprise a first communication system for allowing users to communicate with one another in the real world and/or digital world. The first communication system 700 may be in the form of a chat messenger or other messaging platform. The first communication system 700 may be integrated within the map 112. Thereby, the communication system 700 may prompt a user via a display on the map 112. For instance, once prompted the user may make a simple swiping gesture to automatically communicate a hello signal and/or a request-to-chat signal with another user. Specifically, the user may tap and hold on the icon of another user's avatar U2 and a mini option overlay 704 can be displayed next to the other user U2. The communication option overlay 704 can include the user's associations or other identifying information, a selectable option of the whether or not the user U1 is feeling friendly and wants to talk or not, and also one or more selectable communique icons to easily and efficiently notify the user and other nearby users via corresponding communique prompts generated by the processing unit 220.

The second communication system 702 may allow users to meet up with one another in the real world and/or digital world. The second communication system 702 may be integrated within the map 112. Thereby, the map 112 may display one or more digital communities associated with the users and/or the owner businesses. The communities can be displayed on the map 112 in relation to a physical location, in relation to the locations of multiple users, without a geographical relationship or physical location, and/or in relation to a set timeframe. The second communication system 702 thereby fosters physical and/or digital meetups.

As discussed, the communication system may be in the form of a messenger built into the map 112. This messaging platform allows users to start conversations quickly with digital and/or physical community members. It has built-in, customizable privacy settings that enable users to choose how they want to interact with others. In one privacy setting, for example named ghost mode, a user will be able to use the application 110 without showing their location to other users on map 112. Incoming chat requests will have to be approved manually. In another privacy setting, for example named private mode or community mode, the user may only allow fellow NFT community members to see them on the map or initiate a chat. The active NFT profile picture of the users may determine the associated active community and therefore user visibility on the map 112. However, other NFTs within a user's wallet will allow a user to message other users in the same digital community; though, such users may not be displayed on the map 112. As an example, a user may only change their profile picture once every ten days to prevent abuse of the community mode. If a user transfers their NFT out of their wallet, they will immediately lose access to that community. However, the user may still retain active chat instances in the communication platform. In another privacy setting, named public mode, a user may allow any other users to send direct messages, provided the users are in the same community or within a 20-km, approximately 12-mile, radius.

Depending upon the users' selected communication settings, the ecosystem server 200 may automatically and simultaneously notify users within a preselected community, group, or proximity. For instance, the ecosystem server 200 may automatically send a notification signal to the devices 106 of the users, such as an audio and/or visual indicator, so that the users may visually see and/or hear one another in the real world and/or digital world. For example, if both users have selected community mode, the processing unit 220 may automatically cause each users' device 106 to emit an audio and/or visual signal so that the users may be notified of each other's presence and easily identify one another, fostering an introduction between community members who may not have met one another yet.

The processing unit 220 may incentivize communication and/or physical and/or digital meetups of the users. For instance, the processing unit 220 may generate and grant achievements to the users based upon their communication, meeting attendance, and involvement in the meeting. The processing unit 220 may also grant achievements to meeting organizers based upon the number of attendees, the duration, location of the meeting, and/or the number of meetings held. This functionality aids users in building their own stories alongside their communities, maximizing social interaction and connectivity not just in the digital world but also in the physical world.

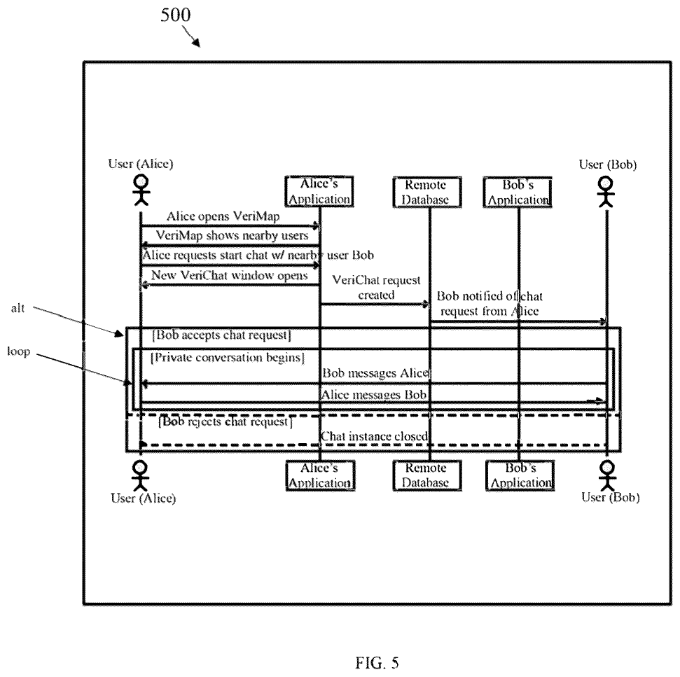

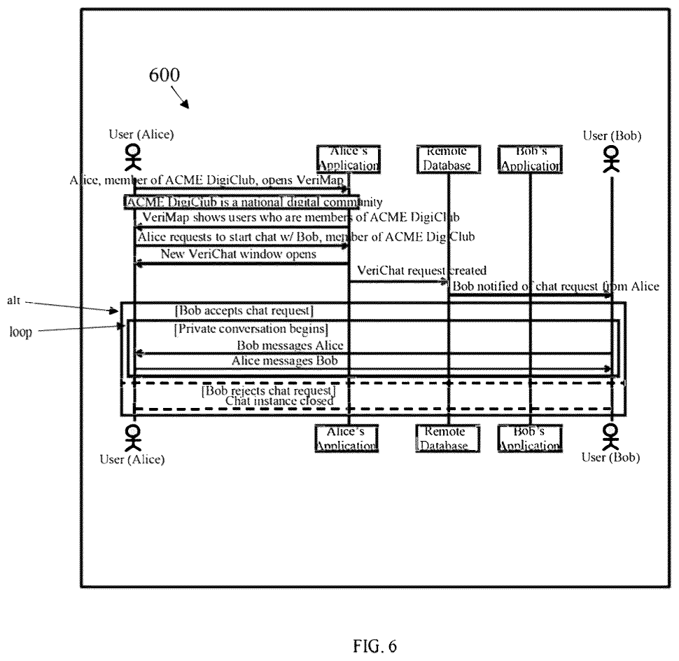

FIGS. 5-6 illustrate flowcharts of communication methods 500, 600 for connecting users to one another. FIG. 5 illustrates a method 500 for connecting users based upon proximity. FIG. 6 illustrates a method 600 for connecting users based upon user characteristics, such as a community or group to which the users belong, such as a NFT community.

In operation, user 1 may open up the application 110. The map 112 may show the avatar of user 1 and the avatars of other users within a predefined community, group, and/or proximity. If desired, user 1 may request to start a chat with user 2. This request is sent to the ecosystem server 200, e.g., memory 210. Then, the ecosystem server 200 sends the request to user 2. If user 2 accepts the request to chat, then the communication platform facilitates messages between the users. If user 2 rejects the request to chat, then the communication platform will not generate a chat instance between the users.

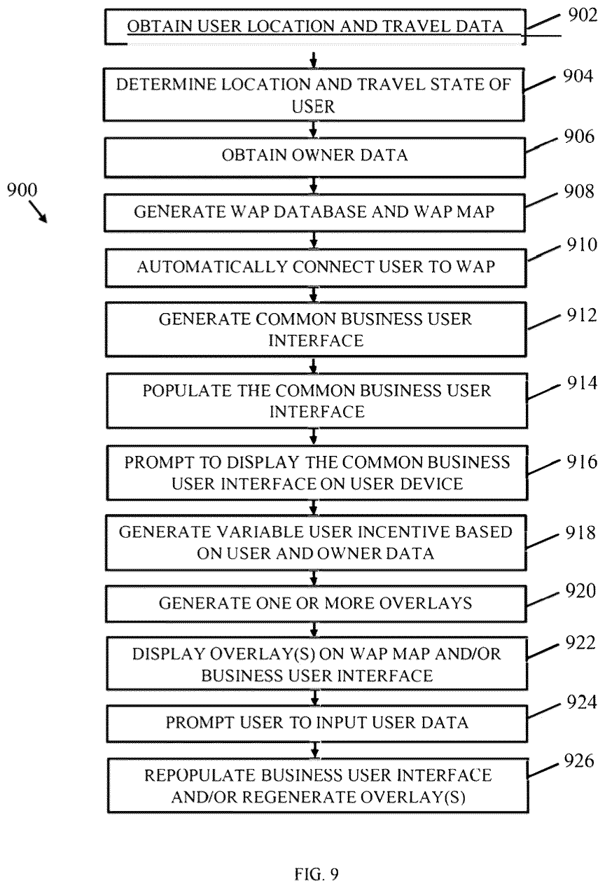

Referring to FIGS. 7-9, the processing unit 220 can streamline business information and incentives to travel to the businesses associated with the WAPs. Specifically, FIG. 9 illustrates a flowchart of a method 900 for establishing communication between businesses who operate WAPs 104 and the users. Initially, the processing unit 220 can obtain user location and travel data (block 902) and determine the location and travel state of the user (block 904). The processing unit 220 can also obtain owner data (block 906). Thereafter, the processing unit 220 can generate the WAP database 212 and the WAP map 112 (block 908). In one embodiment, the processing unit 220 can generate the WAP database 212 and the WAP map 112 utilizing user input adding various WAPs 104. In another embodiment, the processing unit 220 can generate the WAP database 212 and the WAP map 112 utilizing access owner input who may each add their respective WAP(s) 104. Upon the user entering the geofence, the processing unit 220 may automatically connect the user device 106 to the WAP 104 (block 910). The generation module 228 of the processing unit 220 can generate a streamlined common business user interface 800 (block 912). The interface is common or uniform in that it displays the same UI configuration for all businesses, allowing the users to easily identify the business's information and input information themselves. The processing unit 220 may populate the common business user interface with the information of the relevant business (block 914). For instance, the processing unit 220 may populate the business user interface 800 upon the user connecting to the WAP 104 of the business. Alternatively, the processing unit 220 may populate the business user interface 800 upon the user selecting the desired business in the WAP map 112, allowing the user to easily and efficiently search for community and business information. The processing unit 220 can further prompt the user device 106 to display the business user interface 800 (block 916). The processing unit 220 may also generate a variable user incentive which is based on the user data and owner data (block 918). The incentive can be a digital asset, such as a digital award, a digital coupon card, a platform NFT, a business specific NFT, a discount code, a referral link for other users, or other award.

The processing unit 220 can also generate one or more overlays 710, 810, 850, 860 that can be displayed on the WAP map 112 and/or the business user interface 800 (block 920). In one embodiment, the processing unit 220 can generate an incentive overlay 710, 810 which can be in the form of an icon, a video, or a digital asset itself, such as an NFT, that is overlayed onto the display. Optionally, in another embodiment, the processing unit 220 can generate a business notification overlay or popup 850 which can relay to the user information about the goods and/or services of the business. For example, the processing unit 220 may query the business to and accordingly receive business data, which may indicate a special offering, a deal, or a limited supply, among other information. The business information displayed in the overlay 850 may not be related to the generated incentives. Optionally, in another embodiment, the processing unit 220 can generate a user status overlay 860 that can be displayed on the business user interface 800 and/or the WAP map 112, which informs the user of their status in relation to a business or group of businesses associated with one or more WAPs 104. The user status overlay 860 can be generated in real time by the processing unit 220 and may be based on the user data, business data, and/or the generated incentives. For example, the user status can be a tiered status, such as a silver, gold, or platinum status, based on the user's interaction with the business or a categorical representation. For example, the user status can indicate that a user in a top percentage of users, such as the top 1 percent, 2 percent, or 10 percent, etc. The grouping can be based on how frequent one or more users visit the business or grouping of businesses, such as how many consecutive visits in a given time period, e.g., day, week, month, etc., an expenditure amount within a given time period, a number of particular items purchased, how many incentives used or awarded, such as a digital asset, a duration of time spent at the business, and/or a user inputted request to join a particular status. Therein, as the business develops more user traffic it may be more difficult for a given user to achieve a certain status, thereby incentivizing the given user to visit the business more frequently to achieve or maintain their current status. Therewith, users may be incentivized to visit new or other businesses within the ecosystem to more easily earn various incentives, such as special deals, discounts, limited offers, etc.

After generating the overlays 710, 810, 860, the processing unit 220 can output one or more of the overlays 710, 810, 860 to the user device 106 so that it is displayed on the WAP map 112 and/or the business user interface 800 on the user device 106 (block 922). The processing unit 220 can then prompt the user to input user data, such as whether or not the user wishes to take advantage of the generated incentive, special offering, etc. (block 924). The user may also select certain user icons that are fixed at a particular position in each business user interface 800, such as a “hungry” or “thirsty” button 820, 822 within the business user interface 800. The user's inputted data can include, but not limited to, the user's desire for food or liquid, an emotional state, and/or communication state. Once the processing unit 220 receives the inputted user data, the processing unit 220 will repopulate the business user interface 800 and/or regenerate the incentive and the overlay(s) 710, 810, 850, 860 (block 926). Alternatively, the processing unit 220 may remove the overlay(s) 710, 810, 850, 860 if the user has used the incentive, the incentive has become expired, or had a change in status. For example, if the user selected an “I'm thirsty” button 822, the processing unit 220 can display only drink items on the menu and regenerate the incentive to apply to a drink. Therein, the processing unit 220 may further streamline the business's information and the available generated incentives based on sensed user data, inputted user data, and/or business data. Hence, the user does not need to scroll through non-pertinent information, saving time, decreasing data transfer size, and decreasing battery usage.

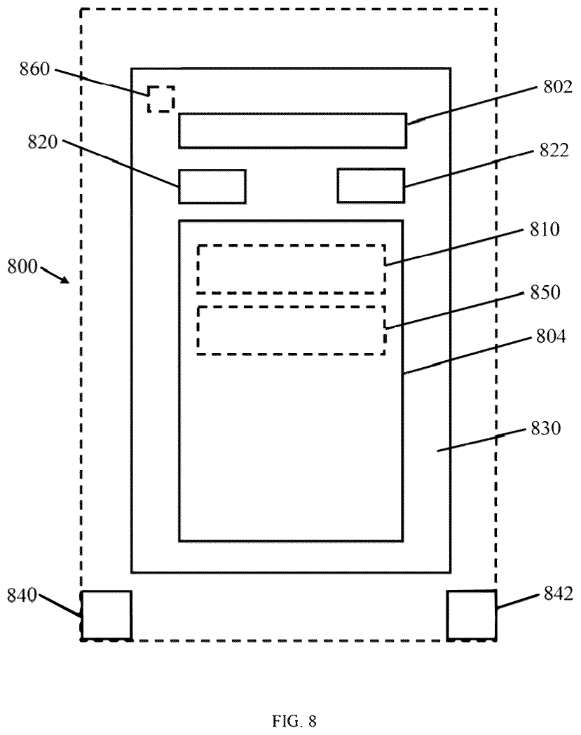

Referring specifically to FIG. 8, the business user interface 800 may effectively replace business specific apps or other modes of communication. The business user interface 800 informs the user of various information associated with the access point owners. The generation module 228 may also integrate access point owner information into the interactive map 112. For example, the business user interface 800 may include a designated business name overlay 802 that displays the name of the business. The business user interface 800 may also include an information portal 804 to display a menu, an event schedule, or other information of the business. The business user interface 800 and/or the interactive map 112 may comprise an in-display overlay or popup 810 that allows the user to quickly and efficiently see any available incentives, e.g. discounts or deals, or events associated with the access point owners. Additionally, the business user interface 800 may include one or more designated buttons 820, 822 for selecting a state or mood of the user. The buttons 820, 822 can be used to streamline information and specifically tailor the information displayed within the information portal 804. Optionally, the business user interface 800 can include a background display or underlay 830, which displays one or more photos or videos related to the business, the user, and/or the community group or current event. The underlay 830 allows the user to obtain information without distracting from the most pertinent information displayed in the overlays and information portal 804. Additionally, the business user interface 800 may include designated buttons 840, 842 to view the WAP map 112 and the user's profile.

The business user interface 800 significantly reduces the time it takes for a user to review and understand a business's offerings. Furthermore, the business user interface 800 increases the efficiency reduces the overall amount of data being transferred, lag time, and energy needed to display non-pertinent information; thus, increasing the quality of life of the user, decreasing computational cost, and augmenting the battery life of the device 106.

The processing unit 220 also validates the system 100 with one or more incentivized validation protocols. For example, the processing unit 220 may conduct a multi-staged validation protocol to identify and verify the WAP 104. The validation protocol can include the validation of the WAP 104 based upon WAP characteristics, such as its ownership, location, connection speed, profile, and other characteristics, the validation of the WAP 104 based upon user data, the validation of the WAP 104 based upon verification data inputted by one or more users, and/or the validation of the user who uses the WAP 104 and/or inputs verification data associated with the WAP 104.

The validation protocol may include a first validation procedure wherein the processing unit 220 verifies user information. The processing unit 220 may verify that the user owns the NFT(s) which is being identified and used by the user. The processing unit 220 may verify the NFT's identifying characteristics, such as a number sequence and/or mint date.

The validation protocol may include a second validation procedure wherein the processing unit 220 checks that a WAP 104 is viable, checks the location and ownership of the WAP 104, for example via Google Places API, checks the location of the user, and verifies that the user is at the location of the WAP 104 which the user has added to the WAP database.

The validation protocol may include a third validation procedure wherein the processing unit 220 checks the time at which the user adds a WAP 104 and a distance between subsequently added WAPs 104. This ensures that the user is physically traveling to each new WAP 104 added to the WAP database. The processing unit 220 may calculate whether the user is spoofing their location, for instance by checking a distance and an estimated time of travel between subsequent WAPs 104 and the user's timeframe in adding subsequent WAPs 104 and determining that the user added the subsequent WAP 104 in an unreasonable amount of time. If the processing unit 220 determines that the user has spoofed their location, then the processing unit 220 may prevent the addition of the WAP 104 or delay the addition thereof. The processing unit 220 may also penalize the user or block the user from adding other WAPs 104.

The processing unit 220 may conduct a fourth validation procedure wherein the processing unit 220 queues a newly added WAP 104 for validation by another user. By way of example only, user 1 (“contributor”) may pair a WAP 104 with a publicly accessible place of business, and this WAP 104 may be automatically added to the WAP database and be listed to other users, for example user 2 (“validator”), to verify the newly added WAP 104 based upon location data of user 1 and 2, activity recognition, and connectivity APIs. If user 1 identifies a WAP 104, then the processing unit 220 may wait to add the WAP 104 to the map 112 until user 2 also accesses the WAP 104 and verifies its viability. The processing unit 220 will also verify the location of user 2 and the WAP 104 which user 2 is presently verifying. Once verified, the processing unit 220 will add the WAP 104 to the map 112. Connecting to a WAP 104 proves that the information stored in the memory 210 is correct and that the users in question are indeed at the location of the WAP 104. This latter proof allows the map 112 to show user avatars alongside other nearby users. Users can then see which establishment other nearby users are located at and when they checked in. If a user wishes to communicate with another user, the user may contact the other user via the communication system(s) of the system 100.

The processing unit 220 may conduct a fifth validation procedure wherein properties of the WAP 104 are securely stored as an additional check to detect spoofing. The processing unit 220 may determine and validate WAP location, upload and download speed, usage rates, and ranges.

Therein, the ecosystem server 200 relies on multiple proof mechanisms that reward good users and punish nefarious users. The processing unit 220 relies on existing network protocols, e.g., 802.11, TCP/IP, HTTPS, mobile smartphone hardware, e.g., GPS chips, Wi-Fi® chips, and mobile provider APIs for geolocation, device integrity, connectivity, and authentication. The ecosystem server 200 may also utilize device attestation and integrity services, e.g., Google Play Integrity, DeviceCheck, to detect modified copies of data. For example, the system 100 may detect modified copies of the application 110 which may be attempting to communicate with the server 200.

The processing unit 220 may also conduct a multi-staged validation protocol to verify communication and/or meetups between users. The processing unit 220 can utilize proof of connection to validate social connections. The communication platform verifies the location of users and their proximity to one another before enabling proximity-based conversations. Another communication platform, for example a real world meetup platform, utilizes user location data, WAP data, and user activity to validate meetup attendance, be it in the physical and/or virtual world.

The processing unit 220 may also conduct a multi-staged incentivization protocol to incentivize users to add new WAPs, communicate with one another, obtain NFTs, and keep using the application 110. The incentives may be web2 and/or web3 incentives. The incentives, e.g., awarded achievements and collectibles, may be earned by participating in proof-of-connection activities. The incentives may include but not limited to achievements, payments such as a token associated with the system 100, a crypto currency, an NFT related or unrelated to the system 100, custom avatars, avatar apparel, leaderboard status, and/or in-store credits, discounts, or awards specific to one or more businesses of a WAP 104 or group of WAPs 104. For example, the processing unit 220 may generate digital assets associated with the ecosystem platform and/or owner-specific digital assets, such as NFTs, associated with the access point owners and award such digital assets to the users upon assisting in the completion of certain verification protocols, attending events, and/or purchasing items at the business of the access point owners and/or partner access point owners.

Achievements may include basic, advanced, city, unique, fun, and/or early adopter achievements. Basic achievements include one or more tutorials on participating in the ecosystem. Other basic achievements may include adding new WAPs 104, starting a chat with a local or digital community member, and attending an in-person or virtual meetup. New categories of achievements unlock once the user has completed the minimum set of basic achievements. Early adopter achievements may be reserved only for the very first users of the system 100. City achievements showcase different cultures, landmarks, and establishments that give every city life. Holders of these achievements will help the system 100 generate a global ambassador program. Once a user is listed as an ambassador, the user can create new city-specific achievements for other users to achieve. Unique, seasonal, and fun achievements may also be included. One example of a fun achievement is a “Coast-to-Coast” achievement, which users achieve by validating two WAPs 104, each within 5 km of the westernmost and easternmost points of the continental United States. New achievements can be submitted and approved by thoughtful contributions from the users. Hidden achievements not publicly advertised may also be included. Seasonal “scavenger hunts” achievements may also be included.

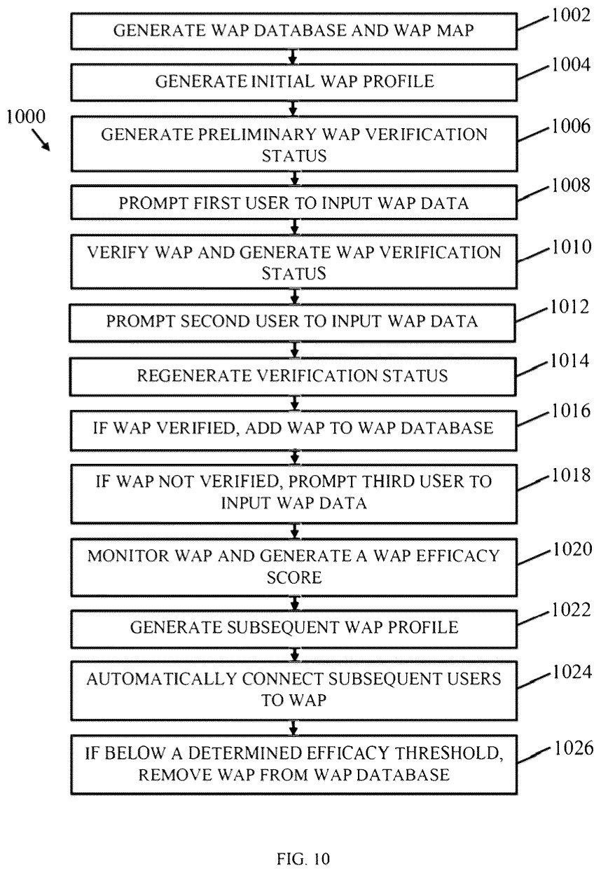

By way of example only and specifically referring now specifically to FIG. 10, there is shown a verification method 1000. In operation, the processing unit 220 can initially generate the WAP database 212 and the WAP map 112 (block 1002). The processing unit 220 can also generate an initial WAP profile (at block 1004). The WAP profile can comprise inputted, sensed, and generated characteristics of the WAP 104. For example, an initial WAP profile can comprise a generated geofence, generated by the processing unit 220, based on a known boundary line of the building, including its walls, floors, and ceilings, retrieved from a third party database.

The processing unit 220 can generate a preliminary WAP verification status (block 1006). The preliminary WAP verification status can comprise a status of whether or not the WAP 104 is associated with a particular business and in good working order. Therein, the processing unit 220 can create a confidence score on the likelihood the WAP 104 is viable and housed within a given building.

Thereafter, the processing unit 220 can verify the WAP and generate a WAP verification status, utilizing a neural network and/or user input from two or more users. To verify the WAP 104 utilizing the user input, the processing unit 220 may initially prompt a first user to input WAP data associated with a given WAP 104 (block 1008). Such data can include the name of the business, the name of the WAP 104, and/or the password of the WAP 104. Once a successful connection is determined, the processing unit 220 verify that WAP 104 is operational and generate a WAP verification status, such as active and unverified by a subsequent user (block 1010). As an added layer of protection and accuracy, the processing unit 220 may prompt a second user to input WAP data associated with the WAP 104 added by the first user (block 1012). The processing unit 220 can determine whether the second user inputted the same data as the first user, e.g., the passwords match, and is successfully connected to the WAP 104. Thereafter, the processing unit 220 can generate a user-based preliminary verification status based on the owner data and the inputted WAP data from the first and second users. The processing unit 220 may then generate a WAP verification status based on the preliminary user-based preliminary verification status. If and when a prior verification status was previously generated, based on user input and/or the neural network, the processing unit may regenerate the verification status to accordingly provide an updated verification status (block 1014).

Optionally, the processing unit 220 may also prompt the first user and/or the second user to provide user feedback on the efficacy of the WAP 104. For example, if the WAP 104 has a strict firewall, then the processing unit 220 would likely generate a verified status as both first and second users would technically have provided the same information and be successfully connected to the WAP 104; however, the usability of the WAP 104 may be undesirably low due to the firewall. Thereby, the processing unit 220 may alter the verification status based on user feedback if the user indicates that the WAP 104 is practically unusable due to its firewall.

If the WAP 104 is verified, the processing unit 220 can add the WAP 104 to the WAP database 212 and update the WAP map 112 to indicate that the WAP 104 is verified and in good working condition (block 1016). If the WAP 104 is not verified, the processing unit 220 may prompt a third user to input WAP data associated with the WAP 104 in question (block 1018). The processing unit 220 will compare the inputted WAP data from the first, second, and third users and check for any dissimilarities. If the inputted WAP data all matches, then the processing unit 220 may determine an unverified status and shadow ban the WAP 104. If the inputted WAP data is dissimilar, then the processing unit 220 may prompt a fourth user to input WAP data and recalculate the accuracy of the inputted information. If the WAP data is dissimilar, the processing unit 220 may generate a probability verification status, indicative of a high or low likelihood efficacy, or a final unverified status output signal and communicate such to the access point owner so that they may remedy any issue with their WAP 104. Accordingly, the unverified WAP 104 can be removed from the WAP database 212.

Additionally or alternatively to the user-based verification protocol, the processing unit 220 may generate the preliminary verification status via a neural network (block 1006). For example, the processing unit 220 may comprise a machine learning module that conducts a string similarity calculation using a machine learning algorithm. The neural network can include a training algorithm that was trained on identifying a dataset of previously verified WAPs. For example, the training data can comprise business names and names of wireless networks which match with one another, and the algorithm will identify the similarities in the names with natural language processing to ultimately generate a confidence score that the WAP 104 corresponds to a particular business based on the name similarity. Additionally, the training data can comprise business property lines, building dimensions, and RF signal strengths of the WAP 104 to train the neural network to identify progressively weaker RF signals with building dimension and/or property line limits. Hence, the neural network can determine a verified confidence score of the WAP 104 by conducting a string similarity calculation using the machine learning algorithm. The neural network can also generate a preliminary AI-based verification status based upon the verified confidence score. The processing unit 220 can then generate a WAP verification status that is based on the preliminary AI-based preliminary verification status (block 1010). If the WAP does not have a password, then the processing unit 220 may begin automatically connecting users to the WAP 104 upon detecting the users have entered the determined geofence of the WAP 104.

After adding a WAP 104 to the WAP database 212, the processing unit 220 may monitor the WAP 104 and determine the efficacy, e.g., usability, of a WAP 104 (block 1020). The efficacy score can be a measure of RF signal strength, connectivity speeds, and/or traffic patterns, ranging from unusable, poor, average, to great. The processing unit 220 can generate the WAP efficacy score based on sensed WAP data and/or user inputted WAP data.

The processing unit 220 can initially determine an efficacy threshold of the WAP 104. The efficacy threshold can be a predetermined minimum connectivity speed. Alternatively, the efficacy threshold can be a comparative value based upon comparing competing WAPs 104. For instance, the processing unit 220 can determine which WAP 104 has the strongest signal and fastest speeds and accordingly rank the competing WAPs 104 from best to worst. The processing unit 220 may then identify that a WAP 104, which is ranked in the middle, constitutes the efficacy threshold. To monitor the WAP 104, the processing unit 220 can track the ease of connectivity, the upload or download speed, the average time connected to the WAP 104, and RF signal strength.

In continuing the protocol, the processing unit 220 can generate additional or subsequent WAP profiles (block 1022) and automatically connect subsequent users to these WAPs 104 (block 1024). For each WAP 104, the processing unit 220 can generate an efficacy score. If in the event the processing unit 220 determines that a WAP 104 is below the efficacy threshold, then the processing unit 220 can remove the WAP 104 from the WAP database 212 (block 1026). The processing unit 220 may also conduct a decay or loss analysis, wherein the processing unit 220 may remove, or change the verification status of, certain WAPs 104. For instance, the processing unit 220 can determine a duration of inactivity of a WAP 104, and if the inactivity duration is below a preset duration, then the processing unit 220 may change a green, verified status to a yellow, unverified status or alternatively may remove the WAP 104 from the WAP database 212.

Where there are multiple, competing WAPs 104, either in a relatively close geographical region or within the same building or building complex, the processing unit 220 may monitor and generate efficacy scores for each WAP 104. The processing unit 220 may compare the WAP efficacy scores and accordingly rank the WAPs. The processing unit 220 can prioritize the WAPs based on their efficacy scores for preferentially connecting the user device to whichever WAP has a higher ranking.

Referring now collectively to FIGS. 7 and 10, when generating a WAP profile of a given WAP 104, the processing unit 220 may dynamically generate a geofence of the WAP 104. Initially, the processing unit 220 can generate an estimated geofence GP based on a proximity ring centered on a center point of a building or at a known location of a router. Therein, the processing unit 220 can determine the center point of a building and estimate the geofence of the WAP 104 to be approximately a circular perimeter of 50-150 ft (15-45 m) therearound. The processing unit 220 can also determine a dynamic geofence of the WAP 104, wherein the processing unit 220 determines the property lines and dimensions of the building on the property, which it may obtain from a third party database. From map data, the processing unit will then determine the building density, e.g., whether the building is in a city block or distanced from juxtaposed businesses. Thereafter, the processing unit 220 will generate the dynamic geofence GD which will range between the property line, an arbitrary set maximum, and an approximate center point of the building or location of the router, an arbitrary set minimum, depending upon adjacent buildings and/or adjacent WAPs 104. The processing unit 220 can also adjust the dynamic geofence GD to identify patios and outdoor seating environments within the property lines but outside of the building itself.

Therewith, the processing unit 220 can generate a dynamic geofence by additionally monitoring the RF signal strength. For instance, the AI processor 222 may incorporate building data, WAP characteristics, and/or user activity to determine the dynamic geofence GD. The AI processor 222 may determine the RF strength of the WAP 104 by logging the RF signal strength and connectivity speed between the user devices 106 and the WAP 104 and also the locations of the user devices 106. After determining where the weakest and slowest points are, the processing unit 220 will remove those regions from the geofence, resulting in a dynamic geofence based at least in part upon on RF signal strength of the WAP 104. Such a dynamic geofence can be especially useful when there are multiple WAPs 104 in a single building, such as an airport. The processing unit 220 can accordingly connect the users to the more suitable WAP 104 based on the dynamic geofence GD. For example, even though there may exist overlap between the WAPs 104 and even though the user device 106 may be physically closer to a less suitable WAP 104, the processing unit 220 can connect the user device 106 to the most connected to WAP 104, the WAP 104 with the highest connectivity success rate, and/or the WAP 104 with the greatest RF strength and/or speed.

The dynamic geofence GD is more accurate than the estimated, proximity based geofence GP. As can be appreciated, in densely populated cities, the dynamic geofence GD is preferred and will save on computations and battery as the processing unit 220 will not try to connect a user device 106 as the user walks by a building but will connect the user device 106 when the user enters the building and gets closer to the location of the router of the WAP 104.

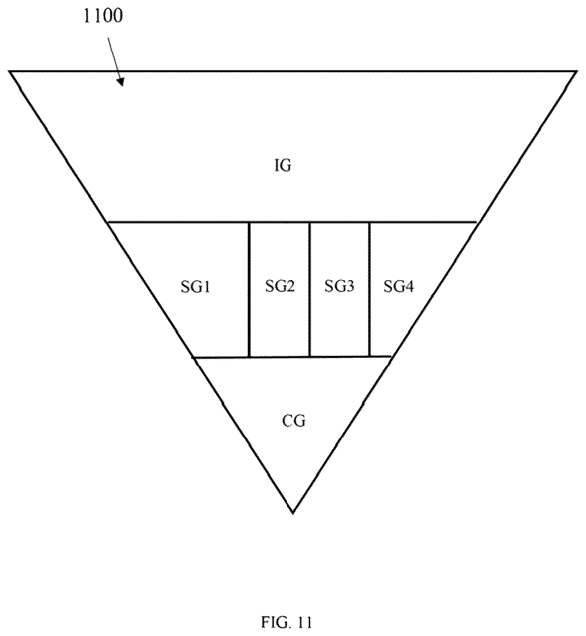

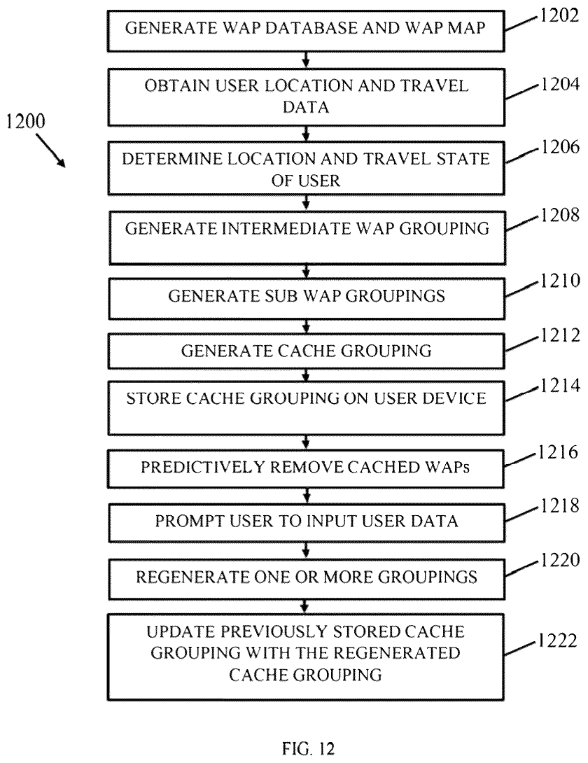

Referring now to FIGS. 11-12, the processing unit 220 can infinitely cache the ecosystem such that the users may be automatically connected to wireless internet wherever they travel, whether or not they are online, as the infinitely cached grouping of WAPs is stored in the memory of their user devices 106. FIG. 11 illustrates a schematic of an infinite caching system 1100. FIG. 12 illustrates a flowchart of a method 1200 for infinitely caching the most pertinent WAPs 104 on the user device 106.

One reoccurring issue with user devices 106 is memory or storage space, which in turn limits the total number of cached WAPs 104 saved on a phone. Another reoccurring issue with user devices 106 is energy consumption depleting battery life, which in relation to caches effectively limits the number of times of user device 106 can connect to various WAPs 104. Another issue arises from offline usage, wherein if the user is not connected to the internet, the user device 106 cannot display the WAP map 112. The infinite caching system 1100 pre-generates groupings of WAPs 104, and similarly to a funnel, sifts through the various possible WAPs 104 and allows only the most pertinent WAPs 104 to be cached on the user device 106, saving storage space and decreasing energy consumption as non-pertinent WAPs 104 are effectively ignored. Additionally, the processing unit 220 can predictively and automatically save various data on the user device 106 for offline usage, such as portions of the WAP map 112, communication data, and business data associated with multiple different business in a given region of the WAP map 112. As a further benefit, the infinite caching system 1100 speeds up the query or synchronization process when connecting the user device 106 to a WAP 104 because the such data has been already cached in the user device 104 before the user has traveled to the location of the WAP 104.

The processing unit 220 may initially generate the WAP database 212 and the WAP map 112, as discussed above (block 1202). The processing unit 220 can obtain user location and travel data, as discussed above (block 1204). Therein, the processing unit 220 may not decide to conduct the method 1200 if the user is not walking or in a still state, effectively pausing the auto-connect capability to conserve battery life. The processing unit 220 can determine the location and travel state of the user, as discussed above (block 1206). Out of all the WAPs 104 in the WAP database 212, the processing unit 220 can generate a hierarchy of groupings of WAPs 104 which ranging from least to most pertinent. The processing unit 220 can group the WAPs 104 by geographical region, frequency of connectivity to the user device 106, relevancy, recency, user data, WAP data, type of access point owner, generated efficacy score, and/or generated WAP profile.

The processing unit 220 may generate a first, intermediate WAP grouping IG that is based upon a common geographical region associated with the particular user device 106, such as a state, city, or region wherein the user presently resides (block 1208). From the intermediate WAP grouping IG, the processing unit 220 can generate two or more sub WAP groupings SG, e.g., SG1-SG4, composed of WAPs 104 that are more pertinent (block 1210). The sub WAP groupings can be based upon the intermediate WAP grouping IG, WAP data, and user data, such as past connectivity data, the user location data, user travel data, and/or user interests.

The processing unit 220 can then generate a cache grouping CG based upon the two or more sub WAP groupings and the user data (1212). The cache grouping CG can be composed of only one or multiple WAPs 104, such as 1, 20, 40, or 100 WAPs 104. The processing unit 220 can also prioritize WAPs 104 by frequency of use. Thereby, processing unit 220 may always include one or more WAPs 104 in the cache grouping CG, which the user frequently uses, like the WAP 104 of their home address or favorite coffee shop. The processing unit 220 can then store the cache grouping CG on the user device 106 (1214).

Optionally, the processing unit 220 can predictively remove one or more WAPs 104 in the cache grouping CG stored on the user device 106 (block 1216). For example, if the processing unit 220 detects that the user is about to or already has traveled to a different region or a different country, then the processing unit will uncache the cache grouping CG from the user device 106. Alternatively, the processing unit 220 may not remove the WAPs unless and until a new grouping has been determined.

Additionally, as an optional step, the processing unit 220 can prompt the user to input user data indicative of any travel plans or schedule (block 1218). The prompt can be contingent on the user leaving or entering certain regions or geofences. For example, if the user travels out of a known proximity, such as a certain radius from their home or most connected to WAP 104; then, the processing unit 220 may prompt the user to input their travel plans. Additionally, for example, if the processing unit 220 detects that the user has entered the geofence of an airport, the processing unit may request that the user input their travel plans or an end destination to precache the desired WAPs 104.

Upon storing the cache grouping CG, the processing unit 220 can automatically save map data for offline usage, if and when the processing unit 220 determines that the user has traveled outside of a most frequented geofence, inputted travel or event data, and/or entered a certain geofence of a WAP 104, such as a transportation hub, e.g., international airport, train station, etc. Thereby, downloading data for offline usage can be contingent on the presently generated cache grouping CG.

As the user travels, the processing unit 220 can regenerate one or more of the WAP groupings IG, SG, CG, based at least in part upon the user location and user travel data (block 1220). For example, the processing unit 220 can regenerate the sub WAP groupings SG and also regenerate the cache grouping CG based on the regenerated sub WAP groupings SG. The regenerated cache grouping CG is different from the previously stored cache grouping CG. Thereafter, the processing unit can update the previously stored cache grouping CG with the regenerated cache grouping CG (block 1222).

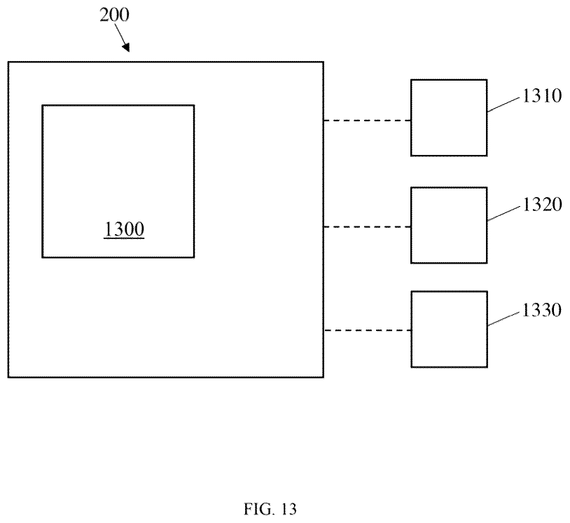

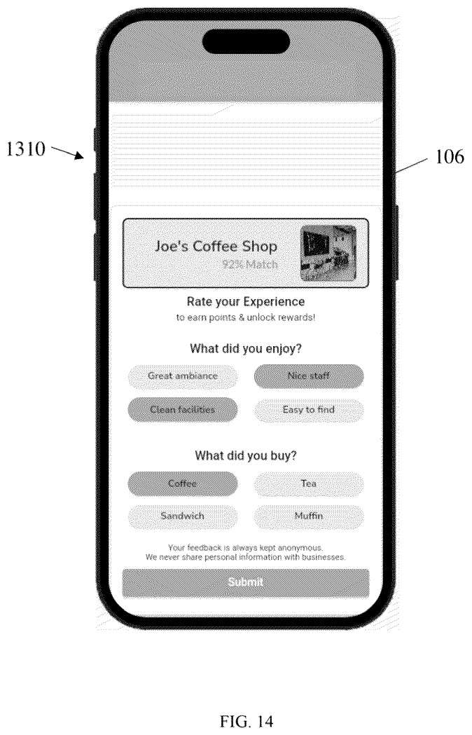

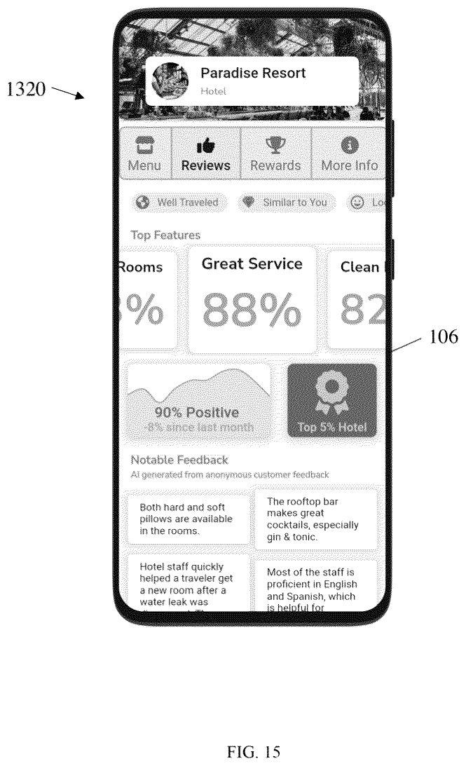

Referring now to FIG. 13, the ecosystem server 200 can further comprise a review or ratings system 1300 that collectively receives ratings from users, verifies the ratings, curates the ratings according to a particular user or grouped subset of users, and outputs and displays the ratings (to the users and/or business owners) based on generated priority scores in real time. Referring now collectively to FIGS. 13-15, the ratings system 1300 of the ecosystem server 200 may further comprise one or more additional interfaces, such as a ratings interface 1310, a display interface 1320, and/or a business interface 1330 for business owners to view their business ratings or user ratings, which may or may not be separate interfaces or incorporated with one another and/or within other interfaces discussed herein. FIG. 14 illustrates a ratings interface 1310, displayed on a user device 106 or other device, which allows a user to input rating or review data associated with the subject business, location, or other service or point of interest. FIG. 15 illustrates a display interface 1320 for displaying the curated ratings on a user device 106 or other device.

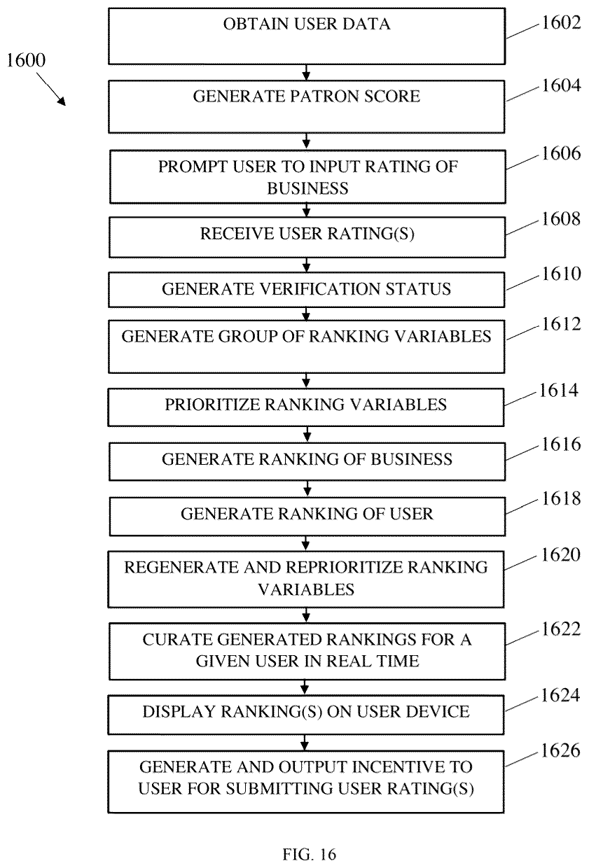

FIG. 16 illustrates a flowchart of a ratings verification and display method 1600 according to an embodiment. The steps of the method 1600 may be performed by the processing unit 220. The processing unit 220 can initially obtain and receive user data, which may include location data, travel data, user characteristics and other interests, and other user data of other users associated with the subject user (at block 1602). The processing unit 220 can generate a patron score associated with the subject user desiring to input a rating for the business (at block 1604). The patron score can be a binary score identifying whether or not the user is presently or was located on the business premises. The patron score can be a percentage score based on user location data, an amount of time spent at the business, a number of times a user previously visited the business, and/or actual or estimated purchases at the business by the user. Optionally, the processing unit 220 may prompt the user (or grouping of associated users) to input a rating of the business based on the generated patron score (at block 1606). Alternatively, the user may of their own volition may input a rating of the business without first being prompted by the ecosystem server 200. The ecosystem server 200 may also send subsequent reminder prompts based on user location data or a present time period. The processing unit 220 may generate predetermined ratings or a listing of predetermined ratings based on business data inputted by the business owner, business data sensed by the ecosystem server 200, such as business type, location, hours of operation, etc., user characteristics, such as user language preferences, travel data, a determined travel state (such as moving or stationary), user ratings from friends of the subject user, and other user data.

The processing unit 220 can receive the user rating(s) from one or more users and other user inputted data germane to the rating, such as the user's intent or purpose in visiting the business, the user's mood, whether the user was alone or with friends, and/or purchases made, coupons, freebies, or other benefits redeemed while at the business (at block 1608).

The processing unit 220 can generate a rating verification status, thus verifying the legitimacy of the received user rating(s) from the one or more users based on user location data, patronage time data, business data, the age of the user's inputted review (indicating the relevancy of the review based on temporal proximity), a duration of time that a rank or review or other identifier is deemed valid based on business data and/or user data of the reviewer (at block 1610). The verification status may be a binary identifier or a weighted percentage wherein an incredulous ranking is given less weight or affect once applied to an overall ranking based on other reviews from other users. For example, ranks that fall outside of a relevancy time period (such as more than one year old) may be weighted less than newer rankings. The verification status associated with a given user-provided rank or other data can be generated by the processing unit 220 at any desired time, such as upon first receiving the ranking from the user and/or at preset time intervals such as every six months.

The processing unit 220 may identify and generate a group of one or more ranking variables (at block 1612). The ranking variables may include a user identifier, a business identifier, a generated score associated with the user and/or the business, a patronage time identifier, a time-of-day identifier, time-of-year identifier, a weather status, and other identifiers or statuses pertaining to the user, related users, the business, related business, current events, unrelated business or travel data of other users or non-users within a given proximity of the subject business, the geographical region, and/or weather or season. For example, the processing unit 220 can generate a grouping of ranking variables including a qualified status of the user based on the user's review history of prior reviews of other businesses and/or self-reported qualifications. Additionally, for example, the processing unit 220 can generate a grouping of ranking variables including a qualified status based on user physical characteristics, e.g., height, weight, age, demographic, gender identity, etc., sensed or received user data, including user characteristics, user travel data, user relationship status, the generated patron score, sensed or received business data, including business type, business location, hours of operation, services or products provided, data of other businesses relating to the subject business, traffic data, previous or projected weather reports.

Thereafter, the processing unit 220 may prioritize the ranking variables by assigning a priority level to, i.e., weighting, the ranking variables within the group of ranking variables (at block 1614). The processing unit 220 may prioritize the ranking variables based on preset metrics of type or kind of reviews, user data, business data, map data, time and/or season data, and/or weather data.

The processing unit 220 may then generate the ranking(s) of the businesses (at block 1616). For example, the processing unit 220 can generate one or more business scores, such as a rank, a text review, a graphic, an illustration or diagram, a color rating, a percentage identifier based on user ranks and/or other business rankings, and/or other identifiers.

The processing unit 220 may also generate a ranking of each user who has previously provided a ranking of a business based on user data, engagement data of whether or not the user's review was engaged with or determined as useful or not as determined by other users upon being prompted to indicate such by the processing unit 220 (at block 1618).

The processing unit 220 can regenerate the group of ranking variables and reprioritize the ranking variables within the regenerated group of ranking variables (at block 1620). In one embodiment, the processing unit 220 may initially generate a grouping of primary ranking variables and assign a prioritization factor to each ranking variable, at blocks 1612 and 1614; and thereafter, the processing unit 220 may generate one or more secondary ranking variables, assign prioritization factors thereto, and then reprioritize the primary ranking variables based on the secondary ranking variables. In one embodiment, the processing unit 220 can generate ranking variables in the form of a categorical factors, e.g., venue type, existence of outdoor seating, language of menu or staff, occupancy, business location, etc., and can generate secondary ranking variables in the form of conditions, e.g., whether or not it is presently raining, mode of transportation, user mood, user expertise or desires, etc., which are then used to reprioritize the initially generated ranking variables. For example, if a secondary variable of present weather indicates that it has just begun to rain in a shared region, another secondary variable, wherein which both of the subject user and business are located, then the processing unit 220 shall automatically deprioritize a business characteristic of outdoor seating of a restaurant, which may ultimately alter the end outputs provided to the subject user. Hence, the processing unit 220 can reweigh (or reassign priority factors) of certain ranking variables in order to subsequently display the most relevant ratings, user reviews, or suggestions to a given user, based on secondary ranking variables, user data, business data, map data, weather data, and other data in real time.

The processing unit 220 can specifically tailor or curate the generated rankings of the businesses and/or the rankings of the users for a given subsequent user who is trying to evaluate the business or user in question (at block 1622). In curating the generated rankings of businesses and/or users, the processing unit 220 may generate business rankings of the top five most relevant businesses, by assigning less weight to ratings from unalike users and assigning more weight to ratings from alike users, such as relevant user reviews from other users that have similar interests, expertise, values, or moods. For example, if a subject user is known to be a coffee connoisseur and is presently searching a new city for a coffee shop to visit, the processing unit 220 may generate a listing of suggested coffee shops that roast their own coffee beans inhouse, as determined by a higher than average menu pricing for a given travel proximity keyed to the user's mode of transportation, a greater than average time spent at the given business location, and other interest or expert specific users who are known to frequent other higher end coffee houses (and who have been previously awarded a categorical, expert designation and priority level by the processing unit 220). Alternatively, for example, if a subject user is known to only spend a few minutes at a minutes at a coffee shop, then the processing unit 220 may generate a listing of suggested coffee shops that have been estimated to have the quickest service, based on current traffic patterns for the user's mode of transportation, current number of patrons at a business, historical weight-time data of prior users, historical flow-through rates based on an average amount of time spent at the business, and a number of bathrooms in relation to the average number of customers at the projected time the user intends to visit the coffee shop. In this circumstance, the processing unit shall deprioritize an ambiance ranking variable and assign greater weight a weight-time ranking variable, as based on the secondary ranking variable of user intent (which in this example is an intent for quick, on-the-go coffee). Additionally, as discussed further herein, the processing unit 220 can remove negative ratings that are outliers and uncommon to other users' ratings.

Once the ranking variables are reweighted and the user rankings are curated, the processing unit 220 can generate and display a listing of the curated rankings associated with one or more businesses, users, and/or or other identifiers, based on the reweighted variables (at block 1624). Hence, the business rankings, user reviews, various identifiers, etc., which are shown to the subject user are specifically tailored to the subject user in real time.

The processing unit 220 can further generate an incentive and output the incentive to the user for the act of submitting one or more user ratings for a given business and/or user, in wherein users can rate other user's reviews (at block 1626). Such an incentive can be in the form of a monetary figure, a coupon, a discount, or reward for the user or the user's friends or followers, a special categorization which prioritizes the user's ratings, or any other desired incentive for motivating the user to provide their input. The processing unit 220 can generate the incentive based on user data, promotions provided by the user, a number or percentage of patrons who have previously left reviews for a given business, a time of day, month, or season, a traffic data, map data, and/or a user categorization previously generated by the processing unit 220 which can be based on their user's review history, patron history, interests, status, or expertise. The processing unit 220 can generate the incentive before the user provides their user rating(s). Alternatively, the processing unit 220 can generate the incentive post providing the user rating(s) and/or post verification of the provided rating.

In one embodiment, the processing unit 220 can generate pre-associations for each user or a group of users (such as users traveling in a friend group on vacation) that are subsequently used to reweight ranking variables. Such pre-associations can be based on user characteristics, dietary restrictions or preferences, goals, explicit interests provided by the user, implicit interests generated by the processing unit 220 upon identifying friend associations, music tastes, travel history to types of points of interests, prior discounts, promotions, or incentives used, etc., and the like. In this regard, the processing unit 220 can generate pre-associations for a given user based on their user data, then global (higher order) associations amongst users, and thereafter reverify the accuracy of the pre-associations for a given user based on the percent overlap or deviance from the global association of the given pool of associated users. The pre-associations and global association amongst users can be used to reweight or otherwise reprioritize the ranking variables to provide the most accurate business rankings, user reviews, and suggestions to each user in real time.

In one embodiment, the processing unit 220 can generate tags, categorical identifiers, awards, and/or achievements for a given business (or group of businesses) based on user inputted ratings or reviews, sensed user data from one or more users, such as the numbers of visits, time spent at the business, grouped user data from users traveling together, map data, weather data, and/or business data. For example, the processing unit 220 may award a business with an identifier, such as a highly rated tag (e.g. great ambiance, great coffee, best brunch spot to talk, etc.), based on a percentage threshold and/or number of users providing directly correlative ratings or feedback or sensed data that the processing unit 220 identifies as correlative to the particular tag, such as based on the time spent at a coffee shop being indicative of ample and comfortable seating. The processing unit 220 can also adjust these business identifiers, which are displayed to the users, based on business data of other businesses, such as pricing data, ratings of related businesses, and/or regional data based on a set region, a proximity to a given user, or transportation time of a given user.

A major disadvantage of existing ratings systems is that all ratings inputted by various customers relating to any business are counted equally. For example, typical rating systems display such data as the total raw number of five-star reviews, four-star reviews, three-star reviews, and the like, and may also display a mathematical average of all of the reviews. In these typical systems, all ratings are counted equally in both the raw totals and the averages without regard to such considerations as, for example: whether the customer is a legitimate customer or a “troll” or competitor entering false ratings for a business that he or she never patronized; for legitimate customers, whether the customer patronized a business only once or is a regular customer of the business; whether the customer regularly patronizes similar businesses and therefore has some basis to fairly compare the business to other businesses; whether the customer belongs to the same age group, gender, or other demographic characteristic as anyone viewing the ratings; or whether the customer's tastes, habits, or lifestyle bear any resemblance or similarity to the tastes, habits, or lifestyle of any other customer or anyone viewing the ratings. This disadvantage springs from the fact that existing ratings systems allow any person to enter a rating anonymously, and all ratings are given equal weight and credibility, without any means of determining anything about the nature of the customer's interaction with the business, including whether the customer visited the business at all before leaving the rating.

The ratings interface 1310 contains various algorithms that operate to enable a first user (an initial user) to input a rating, either text or numerical or another tiered system such as a star rating, associated with the user's opinion regarding the quality of a business and/or its merchandise, goods, or services. The ratings interface 1310 may allow the first user to input a rating consisting solely of a numeric or tiered rating, one or more pre-generated comments, or allow the first user to write text comments of varying length, and/or may also enable the first user to store photos or video footage associated with the rating. The ratings interface 1310 may also be configured or programmed to permit first users to save internet links of interest, such as, for example, a link to the business' website or a link to the first user's own website, as well as links to relevant popular social media platforms that may pertain to the business or to the first user, that the first user believes may be useful to subsequent users viewing the rating.

The rating is stored within the system 100 in such a manner that the data can later be retrieved and manipulated by the ratings interface 1310. The system 100 may be selectively configured or programmed, via internal computer algorithms, to store each rating accompanied by any text comments, photos, videos, internet links, or social media links, along with various other data that may be useful to subsequent users, including, as illustrative and not limiting examples, such things as: the identity and other personal characteristics of the first user who imputed it; the date and time of the event for which the rating was created; the date and time that the rating was entered; the current and historical travel and location data of the first user at the time of the event associated with the rating; links to other ratings inputted by that first user; information pertaining to the business being rated; the types of merchandise, goods, or services offered by the business; links to other ratings inputted in relation to that business; links to other similar business offering competing or alternative merchandises, goods, and services; and other such data that may be useful either to business being rated or subsequent users who may wish to view the rating.

The algorithms within the system 100 may also be programmed such that each rating is stored within the system 100 along with other data, known as “tags,” which identify or classify the rating and the type of business, merchandise, goods, or services being rated. These tags can vary and may be adjusted as needed in accordance with the kinds of business being rated and the needs or desires of subsequent users. These tags may, as illustrative and not limiting examples, be used to classify such things as the type of business being rated, for example: “coffee shop,” “Chinese restaurant,” “men's clothing,” or “women's handbags.” The tags may also be programmed to classify the type of merchandise, goods, or services being rated, for example: “Gucci handbag,” “steak and eggs,” “automotive repair,” or “mens' leather dress shoes.” The tags may also be programmed to classify various features of a business, such as, for example: “ambience,” “magnificent view,” “convenient parking,” or “quality of customer service.” These tags will be described in greater detail hereinbelow.

The ratings verification system 1300 is connected to the ratings interface 1310. This ratings verification system 1300 comprises software algorithms programmed to perform two fundamental tasks. The first fundamental task is an initial screening function that examines a first user's travel and location data to verify that the first user is presently or was previously at the location of the business before allowing the first user to enter a rating for that business (ensuring that the user was indeed a patron at the particular business or location). In more detail, this ensures that only users who actually patronized a particular business and interacted with its merchandise, services, or products may enter ratings, thereby preventing false or “spam” ratings from being entered by false users (such as by automated computer bots or by competitors of the business) who never patronized the business. This initial screening function may also be programmed algorithmically to compare not only the first user's travel and location data to ensure that the first user was actually physically present at the business, but may also be configured to measure whether the first user was physically present at the business for a long enough time to utilize the business' merchandise, services, or products. This prevents false ratings from being created by users who only stepped into the business momentarily for the sole purpose of creating false and misleading ratings, or users whose presence at the business was insufficient to give the business a fair enough chance to make the rating meaningful or valuable to other users viewing the rating. This can be accomplished by a number of methods that will be apparent to those skilled in the art, such as comparing the amount of time that the first user was present within the business to the average time spent by either that first user, or by other users, and/or both, at the business on prior occasions according to their travel and location data. Alternatively, this can also be accomplished more simply by comparing the amount of time that the first user was physically present within the business against a predetermined minimum threshold time calculated either according to a preset algorithm, generated time average which is generated by the processing unit 220, or a time interval selected by the business itself according to its own methodology and preferences.

The second fundamental task performed by the ratings verification system 1300 is to allow subsequent users to view any and/or all ratings previously inputted by any first user. The ratings verification system 1300 also contains one or more additional algorithms that operate in conjunction with the algorithms stored within the system 100 and the ratings interface 1310 which operate to enable the ratings previously inputted to be manipulated in various ways.

As an illustrative and not limiting example, the ratings verification system 1300 may determine, based upon the first user's location and travel data, as well as goals and achievements earned, how many times the first user patronized the business and assign a different measure of weight, credibility, or usefulness to the ratings input by a first user determined to have patronized the business more frequently. By manipulating the stored ratings in this way, ratings given by first users who have frequented the business on many occasions may be assigned greater weight, credibility, or usefulness than ratings given by first users who have only patronized the business once. The ratings verification system 1300 may generate results that reflect the common perception that regular customers of a particular business are likely to give more accurate or more knowledgeable evaluations of the business than first-time customers. How much greater weight, credibility, or usefulness to give to any particular rating as opposed to any other rating may vary based upon such factors as the number of times the first user has patronized the business as well as other factors, including commercial preference, opinion polls, the desires of particular subsequent users, or any of a number of other relevant factors.

Alternatively, or additionally and cumulatively, the ratings verification system 1300 may also contain an algorithm that compares location and travel data, and/or goals and achievements earned, between different first and subsequent users, and assigns a different level of weight, credibility, or usefulness to ratings input by first users whose location and travel data, and/or goals and achievements earned, reflect similarities to the location and travel data, and/or goals and achievements earned, of subsequent users. Such an algorithm enables the various ratings input by different first users to be modified or adjusted according to the tastes, habits, or lifestyles of subsequent users. As an illustrative and not limiting example, the algorithm may be programmed such that the ratings entered by previous first users who previously patronized similar kinds of businesses as a subsequent user—such as, for example, previous users who regularly dined at the same kinds of restaurants as did a subsequent user—are given higher measures of weight, credibility, or usefulness than ratings entered by previous users whose travel and location data indicates that their tastes, habits, and lifestyles were not similar. Alternatively, as another illustrative example, the algorithm may be programmed such that the ratings entered by previous first users who not only patronized the same businesses, but entered similar ratings for those businesses, as a subsequent user may be given higher measures of weight, credibility, or usefulness when viewed by that subsequent user. Alternatively, the algorithm may be programmed such that the ratings entered by a first user are assigned different measures of weight, credibility, or usefulness based upon the goals and achievements earned by the first user. Additionally, for example, subsequent user provided ratings or feedback may receive differing weights, which is subsequently used to adjust the priority of thereof or its position (or page) in the displays of other users. For instance, the processing unit 220 may decrease the weight of ratings or feedback from a user unless and until that particular user has achieved a certain threshold(s) and/or action(s), based on user data and verifiable by the processing unit 220. A threshold or action can be a percentage threshold of reviewers (based on the number and/or quality of ratings or feedback provided), a percentage threshold of patrons (such as a number of visits, time spent at the business, like the top 5% and/or 1% of users, and/or visits or time spend at similar businesses), and/or a certain number of visits to a business and prior reviews (or similar businesses). A certain number of reviews may accordingly classify a user as a top rater of a certain tag or category or classification of business; however, the weight behind the first feedback provided by the first user may be the most weighted feedback until a certain threshold is hit. Therein, the ratings or feedback that is displayed to a given subsequent user is the most accurate ratings or feedback keyed that particular subsequent user.

The algorithms contained within the ratings interface 1310 and ratings verification system 1300 may be configured or programmed to manipulate various ratings input by various first users such as by aggregating, cumulating, compiling, or averaging them in a number of various ways so that subsequent users may view individual ratings, or may view the aggregate, cumulative, compiled, or averaged results. Such results may consist of average ratings, highest and lowest ratings, median ratings, ratings adjusted or unadjusted by the various algorithms, or any of a number of other mathematical processes that a subsequent user may find useful.

All of these various algorithms operate in conjunction with each other so that more than one of the algorithms can be applied to any particular rating or group of ratings. As an illustrative example, a subsequent user may wish to apply one algorithm to retrieve ratings inputted by, for example, only users with similar tastes, habits, and lifestyles; and then from the results of that algorithm apply another algorithm to select only the ratings that have been assigned the highest measures of weight, credibility, or usefulness; and then from the results of that algorithm apply yet another algorithm to calculate an average of the ratings.

The system 100 also contains a display interface 1320 operationally connected to the ratings interface 1310 and ratings verification system 1300. The display interface 1320 operates to enable a subsequent user to select which algorithm(s) contained within the ratings interface 1310 and ratings verification system 1300 to apply, and also operates to display the results produced by those algorithms.

The display interface 1320 may take the form of a software app on the subsequent user's mobile device or computer which provides a method for a subsequent user to interact with the ratings and other data stored within the system 100. The display interface 1320 may be configured or programmed to enable subsequent users to select one or more of the various algorithms programmed within the ratings interface 1310 that select which ratings to view, including the algorithms that aggregate, cumulate, compile, or average the ratings. As an illustrative and not limiting example, the display interface 1320 may contain a button or link that, when selected, enables a subsequent user to choose to retrieve and view only the ratings deemed to be the most credible, trustworthy, or useful in accordance with one or more of the aforementioned algorithms contained within the ratings interface 1310 and ratings verification system 1300, such as, for example, ratings deemed to be the most credible, trustworthy, or useful in accordance with an algorithm programmed to make that determination based upon the first user's historical travel and location data and prior patronage of the business. One illustrative example might be an algorithm that assigns a high measure of credibility, trustworthiness, or usefulness to a rating inputted by a first user who patronized a particular business numerous times, and a lower such rating to a first user who patronized it fewer times. Alternatively, or additionally, an algorithm could also be programmed to assign a higher measure of credibility, trustworthiness, or usefulness to a rating inputted by a first user who patronized a particular business for a lengthy period of time than to a rating inputted by a first user who spent less time there. Alternatively, or additionally, the algorithms could be programmed to assign a higher measure of credibility, trustworthiness, or usefulness to a rating inputted by a first user who previously patronized a minimum threshold number of different businesses engaged in the same field of business, as that first user is likely to be more familiar with the available choices and thus better able to make a fair and accurate comparison between competing businesses.

Alternatively, or additionally, the algorithms could be programmed to assign a higher measure of credibility, trustworthiness, or usefulness to a rating inputted by a first user who previously inputted a minimum threshold number of ratings for that business and/or its competitors. With any and all of these examples, the display interface 1320 could be configured or programmed to enable a subsequent user to retrieve only the ratings whose corresponding measure of credibility, trustworthiness, or usefulness exceed a certain minimum threshold selectable by the subsequent user.

The present embodiment also contemplates that subsequent users can retrieve and view ratings according to certain “lifestyle” criteria. As an illustrative example, the display interface 1320 may contain buttons or links that, when selected, enables a subsequent user to choose to retrieve and view ratings entered by first users whose tastes, habits or lifestyles satisfy certain criteria, such as, for example, first users who dine frequently at certain types of restaurants, or first users who have previously traveled to certain parts of the world. The present embodiment contemplates two principal methods to accomplish this. First, the display interface 1320 could be configured to enable the subsequent user to manually select the criteria to be used, such as, for example, buttons or links that enable the selection of ratings inputted by first users who patronized a particular type of business a certain number of times, or who inputted high ratings for businesses of a particular type relative to other businesses. Thus, as a single illustrative example, a subsequent user could select ratings inputted by first users who frequently patronized sushi restaurants and frequently rated sushi restaurants higher than other types of restaurants. Alternatively, or additionally, a subsequent user could select ratings inputted by first users whose travel habits mirror those of the subsequent user.

The second principal method contemplates configuring or programming the algorithms within the display interface 1320 to automatically pre-select the criteria to be used. For example, the algorithms could be programmed in such a way that the ratings inputted by first users whose travel and location data indicate that they frequented the same, or similar, businesses as did the subsequent user, are given a higher measure of credibility, trustworthiness, and usefulness even without the subsequent user having to manually select that criteria. Therein, like users or users of high credibility may post a review/rating/recommendation and have that be seen by subsequent users, based on predetermined similarities or user-chosen tags and/or criteria. The tags and criteria that users may select can become the default unless other users dodge the tag or decide to have other criteria that matters to them more, in which case other ratings with differing tags and/or criteria shall be displayed to the subsequent user.

Alternatively, or additionally, the algorithms could be programmed in such a way that the ratings inputted by first users for certain businesses were the same as, or similar to, ratings inputted by the subsequent user for those same businesses, are given higher measures of credibility, trustworthiness, and usefulness even without the subsequent user having to manually select that criteria. Alternatively, or additionally, the algorithms could be programmed in such a way that the ratings inputted by first users whose travel and location data indicate that they have traveled to many of the same, or similar, countries or cities as did the subsequent user, are given are given higher measures of credibility, trustworthiness, and usefulness even without the subsequent user having to manually select that criteria. Any of these criteria can also be used in combination with one or more of the other criteria.

The display interface 1320 can be configured or programmed to enable subsequent users to select ratings according to numerous other criteria, including based on mathematical calculations of the ratings. For example, the display interface 1320 may contain a button or link that, when selected, enables a subsequent user to choose to retrieve and view a numerical average of all ratings entered for a particular business. Alternatively, or additionally, the display interface 1320 may contain a button or link that, when selected, enables a subsequent user to choose to retrieve and view all ratings entered by particular individual first users, or all ratings entered by a particular first user associated with a particular business. Alternatively, or additionally, the display interface 1320 may contain a button or link that, when selected, enables a subsequent user to choose to retrieve and view ratings input during certain dates or date ranges. Alternatively, or additionally, the display interface 1320 may contain a button or link that, when selected, enables a subsequent user to choose to retrieve and view ratings input by first users according to certain selectable criteria such as the age, gender, current travel or location data, or other characteristics associated with the first user, including such things as the number of prior ratings inputted by that first user, or the number of ratings inputted by that first user that have been deemed to be of high weight, credibility, or usefulness. Alternatively, or additionally, the display interface 1320 may contain a button or link that, when selected, enables a subsequent user to choose to retrieve and view ratings input by first users whose prior ratings match or correspond or show similarity to ratings previously entered by certain subsequent users; for example, ratings input by first users whose prior ratings are similar to those of a celebrity, or those of the subsequent user. Alternatively, or additionally, the display interface 1320 may contain a button or link that, when selected, enables a subsequent user to choose to retrieve and view ratings input by first users whose historical travel and location data, either instead of or in addition to any ratings entered by the first user, match or correspond or show similarity to other users or to the subsequent user himself or herself.

The display interface 1320 may also contain buttons or links that, when selected, enable a subsequent user to manipulate the retrieved ratings in various ways by applying the appropriate algorithm, such as algorithms for calculating a mathematical average of the retrieved ratings, or median of the retrieved ratings, or retrieve only the highest or lowest rating for a particular business, or retrieve ratings for only subsets of first users possessing certain characteristics, retrieve only ratings for subsets of first users whose historical travel and location data meet certain criteria, retrieve only ratings for subsets of first users whose prior ratings meet certain criteria, ratings for subsets of first users who previously patronized particular types or classes of business, etc. etc.

The display interface 1320 may be configured or programmed such that more than one of the various buttons and links displayed on the display interface 1320 may be selected either sequentially or simultaneously, thereby enabling the subsequent user to choose to retrieve and view ratings to which a combination of more than one algorithm has been selected to apply. Selecting a combination of algorithms enables the subsequent user to choose to retrieve ratings even more closely tailored and targeted to the subsequent user's personal preferences. As an illustrative example, by selecting the appropriate buttons or links, a subsequent user may choose to view ratings inputted according to one criterion (such as, for example, ratings inputted by a particular first user), then apply another criterion (such as, for example, ratings inputted during a certain date range), and then apply yet another additional algorithm that, for example, calculates an average of those ratings. The present embodiment contemplates that any and/or all of the algorithms can operate in conjunction with as many other algorithms as any subsequent user desires. All of these, and more, can be easily accomplished by programming computer algorithms associated with the ratings interface 1310 and the display interface 1320 in a corresponding manner known to those skilled in the art without departing from the spirit and scope of the invention.

The display interface 1320 may also be configured so that subsequent users may direct the ratings interface 1310 and ratings verification system 1300 to utilize the tags stored with each rating in determining which ratings to retrieve and display, either by themselves, or in combination with the ratings and other data. For example, if a subsequent user wishes to only view ratings associated with businesses that sell a particular kind of merchandise, the subsequent user can select an appropriate button or link on the display interface 1320 to direct the ratings interface 1310 to retrieve only ratings for which that tag was stored. Likewise, and as a further illustrative example, if a subsequent user wishes to only view ratings for businesses with such a feature as “convenient parking,” the subsequent user can select the appropriate button or link on the display interface 1320 to direct the ratings interface 1310 accordingly. The ratings interface may also be configured to permit subsequent users to search these tags in combination with other tags, and in combination with the ratings and other data. Thus, as a single illustrative example, a subsequent user who wishes to retrieve view only ratings associated with a particular product, inputted by first users with certain travel patterns, for businesses located within a certain radius of the subsequent user's current location, inputted by first users whose age is within a certain range, by only first users who have inputted a minimum of 50 ratings, and for only businesses with convenient parking and an average ambience rating of at least 3 out of 5, may be permitted to do so by selecting the appropriate button or link, or combination of buttons or links, on the display interface 1320. The number of combinations is virtually limitless and can be accomplished easily by programming the display interface 1320 accordingly as needed or desired by subsequent users.

The system 100, the ratings interface 1310, the ratings verification system 1300, and the display interface 1320 may be configured or programmed to either provide any and/or all subsequent users with access to all of the ratings and other data, or they may be configured or programmed to limit the kind of data that any and/or all subsequent users may retrieve. The system 100, the ratings interface 1310, the ratings verification system 1300, and the display interface 1310 may be configured or programmed to permit different subsequent users to retrieve and view any and/or all of the ratings and other data, while prohibiting other subsequent users from retrieving and viewing certain types of ratings or associated data. In certain situations, it may be desirable for commercial purposes, and for reasons of privacy or confidentiality, to prohibit subsequent users from retrieving and viewing certain ratings or certain types of data stored with the ratings. As a simple illustrative example, the system 100, the ratings interface 1310, the ratings verification system 1300, and the display interface 1320 may be configured or programmed to prohibit subsequent users who are minors from retrieving ratings or other data relating to bars, liquor stores, or adult-oriented businesses. Other examples may be easily envisioned in which certain kinds of subsequent users ought to be prohibited from retrieving and viewing certain ratings and data.

Similarly, the ratings verification system 1300 may be configured or programmed such that the system 100 does not accept or store ratings of certain kinds of businesses, certain kinds of products, or ratings that violate certain rules. As illustrative examples, the ratings verification system 1300 may be programmed not to permit ratings of Cannabis stores in states where Cannabis is illegal, or ratings of other products that violate laws such as stolen property. The ratings verification system 1300 may also be programmed not to permit ratings accompanied by text comments, photos, videos, internet or social media links that contain profanity, foul language, violence, nudity or adult-oriented images. The ratings verification system 1300 may also be programmed not to permit ratings of businesses that may not be illegal but for other reasons are not desired to be included, such as adult-oriented businesses, businesses affiliated with controversial political or religious causes, businesses affiliated with fringe organizations (such as Nazis or the KKK or religious cults), or other businesses that may offend subsequent users or potentially violate social norms.

One exemplary embodiment will now be described in order to illustrate how the system 100, the ratings interface 1310, the ratings verification system 1300, and the display interface 1320 operate in conjunction with each other. This embodiment is intended to be illustrative, not limiting, and many other alternative embodiments can easily be contemplated without departing from the spirit and scope of the invention.

In this exemplary embodiment, a first user patronizes a business with a public Wi-Fi® network. When his mobile device is in close enough proximity, it connects with the business's Wi-Fi®. The first user spends a certain amount of time within the business premises. The system 100 records the first user's connection to the business' Wi-Fi® and tracks the amount of time the mobile device is connected. During that time, the first user purchases some merchandise, goods, or services from the business. After completing the purchase, the first user wishes to enter a rating reflecting his satisfaction with the business and its merchandise, goods, or services. In order to encourage as many first users as possible to enter such ratings, the system 100 can be configured to offer an enticement or reward for every rating, such as a coupon or discount code against future purchases.

When the first user uses the display interface 1320 to enter the rating into the ratings interface 1310, the ratings verification system 1300 operates to verify that the first user was physically on the business premises based upon the existence of the connection between his mobile device and the business Wi-Fi®, as well as his travel and location data. Only if the first user was physically present within the business' premises is the first user permitted to enter a rating for that business. If the ratings verification system 1300 is unable to verify that the first user was physically within the business, then the first user will not be permitted to enter a rating for that business. The ratings interface 1310 and ratings verification system 1300 can also be programmed so that the first user is only permitted to enter a rating if he or she was not only physically on the business' premises, but also remained there for sufficient time to complete a purchase based either upon some predetermined criteria or upon, for example, a mathematically calculated average time required to complete a purchase based upon accumulated travel and location data from all users. Other criteria for determining whether a first user remained within the premises long enough to complete a purchase may also be utilized. If the ratings verification system 1300 determines that the first user had not been within the business' premises at all or was present only for an insufficient amount of time to have completed a purchase, the first user will not be permitted to enter a rating for that business, and instead the ratings interface 1310 will display an appropriate notification. Any rating that the first user attempted to enter into the ratings interface 1310 will not be stored as data within the system 100.

On the other hand, if the ratings verification system 1300 determines that the first user was within the business' premises for sufficient time to complete a purchase, the first user is permitted to enter a rating associated with that business. The first user may enter a rating of, for example, one to five stars, along with any text comments describing the business, and possibly photographs of the business or its merchandise, goods, or services. The user may also submit a photograph or video of their interaction, along with any text comments and/or internet or social media links. The videos may be videos taken by the first user, or they may be videos previously uploaded by other people to external social media platforms such as TikTok or Instagram that the first user copies or links into the display interface 1320. This rating, along with any text comments, photos, or other information entered by the first user, is stored within the system 100 along with the first user's travel and location data, and other data and/or tags as described hereinabove. Therein, the processing unit can verify that the user was indeed at the business location via verifying the user's travel history, before, during, and after visiting the business, the amount of time spent at the business, the location metadata associated with the captured image data provided by the user's device 106, and verifying the various secondary factors such as the time of day, the building floor plan, structure, or furniture etc., by comparison to image data provided by the business or other users, preventing spoofing of location or false AI generated reviews.

Thereafter, subsequent users considering whether to patronize that business can access the data stored within the system 100 in a variety of ways using the display interface 1320 to direct the ratings interface 1310 accordingly. For example, the subsequent user can press an appropriate link or button on the display interface 1320 that corresponds to the business, and can direct the ratings interface 1310 to retrieve all ratings entered by any and all first users associated with that business, along with text comments, photos, or other data entered by first users. Even using this simple version of the ratings provides advantages over conventional ratings systems because the subsequent user knows, thanks to the operation of the ratings verification system 1300, that all ratings were inputted by first users who actually patronized the business and therefore are more reliable and trustworthy than ratings system that lack the ratings verification system 1300.

Alternatively, the subsequent user could press a different link or button on the display interface 1320 that directs the ratings interface 1310 to retrieve certain ratings and further directs the algorithm to manipulate the ratings for a particular business in any one of a number of desired ways. For example, the subsequent user can direct the ratings interface 1310 to retrieve all ratings for a business and calculate a mathematical average of all ratings. Alternatively, the subsequent user can direct the ratings interface 1310 to calculate an average rating of ratings entered only by first users who patronized the business more than once. Alternatively, the subsequent user can direct the ratings interface 1310 to retrieve all ratings inputted by first users who patronized the business more than once. Alternatively, the subsequent user can direct the ratings interface 1310 to calculate an average of all ratings inputted by first users of a certain age or gender. Alternatively, the subsequent user can direct the ratings interface 1310 to calculate an average rating of ratings inputted by first users who patronized certain types or genres of businesses more than once a week. Alternatively, the subsequent user can direct the ratings interface 1310 to calculate an average rating of ratings inputted by first users who have traveled to more than one city within the past 90 days, or any other time frame selected by the subsequent user. Alternatively, the subsequent user can direct the ratings interface 1310 to display the highest and lowest ratings ever inputted for that business. Alternatively, the subsequent user can direct the ratings interface 1310 to calculate a median rating for ratings inputted by users who previously patronized five businesses also previously patronized by the subsequent user. Alternatively, the subsequent user can direct the ratings interface 1310 to calculate a median rating of ratings inputted by first users who previously traveled to at least four cities previously also visited by the subsequent user. Alternatively, the subsequent user can direct the ratings interface 1310 to calculate an average rating of ratings inputted by first users who visited the same businesses visited by the subsequent user and assigned the same ratings to those businesses.

Alternatively, the subsequent user can direct the ratings interface 1310 to calculate an average rating of ratings inputted based on any combination of the above, or other criteria not listed hereinabove as exemplars. The present embodiment does not pertain to, and is not limited to, any particular method or criteria for manipulating the ratings previously inputted by first users. Rather, the present embodiment pertains to the advantages achieved by coupling the ratings inputted by first users with the historical and present travel and location data, goals and achievements earned, and prior ratings associated with those first users, enabling subsequent users to obtain considerably more information relating to the credibility, weight, usefulness, relevance, and trustworthiness of those ratings. The present embodiment also pertains to the advantages achieved by coupling the ratings inputted by first users with the historical and present travel and location data, goals and achievements earned, and prior ratings associated with those first users, enabling subsequent users to screen or extricate, and then mathematically manipulate in multiple ways using varying criteria, the ratings that most closely match or relate to the subsequent user's own travel and location patterns and personal habits, tastes, and lifestyle. Conventional ratings systems cannot achieve either of these advantages.

One disadvantage of existing ratings systems is that customers who patronize a business for even the briefest of moments are permitted to leave ratings for various aspects of a business that they may have glimpsed only momentarily, yet those ratings are counted equally as the ratings inputted by other customers who spent long periods of time in the business and whose experiences are considerably more detailed. For example, existing ratings systems allow a customer who set foot inside a steak restaurant momentarily and who spoke with a single employee for only a minute to input a rating regarding the quality of the restaurant's customer service, and that rating is counted equally as the rating inputted by a customer who spent two hours eating a lavish ten-course dinner and who interacted for long periods of time with multiple employees.

In an alternative embodiment, the system 100 and its components—the ratings interface 1310, the ratings verification system 1300, and the display interface 1320—may be configured or programmed such that a first user is enabled to input different types or tiers of ratings based upon how many times the first user patronized a business, how long the first user patronized the business, the goals and achievement earned by the first user, and other aspects of the first user's travel and location data.

In this embodiment, the ratings interface 1310 is configured or programmed in such a way that a first user may use the display interface 1320 to input a rating for different aspects of features associated with a business. As an illustrative and not limiting example, a first user could be permitted to rate his or her experience with a coffee shop by such things as its overall ambience, its cleanliness, the quality of its coffee, the quality of its food, and/or the helpfulness or attitudes of its employees.

In this embodiment, whether or not a first user is permitted to input a rating for any particular aspect of the business is based upon whether the first user was present inside the business' premises for a sufficient amount of time to form an opinion about some aspect or feature of the business that is likely to be credible, trustworthy, or useful to subsequent users. For example, if a first user was only inside of a business for three minutes, it is unlikely that enough time elapsed for the first user to form a valuable opinion regarding the quality of the food served, as it is generally unlikely that food would have been served and eaten within that short period of time. On the other hand, a first user might be able to form a valuable opinion regarding the overall cleanliness of a business even during a visit lasting only three minutes. As another illustrative example, a first user who has previously patronized a particular business on a number of occasions and interacted with many different employees of the business may possess an opinion regarding the attitudes or abilities of its employees that may be more valuable or useful to subsequent users than the opinion of a first user who is only visiting that business for the first time and only interacted with a single employee on one occasion.

Thus, the present embodiment relates to configuring or programming the ratings interface 1310 and ratings verification system 1300 such that the ability to input a rating regarding different features or aspects of a business, or its merchandise, goods, or services, are progressively “locked” or “unlocked,” or enabled or disabled, based upon the length of time that a first user patronized the business, the number of times the first user patronized the business, or a combination of both.

Again utilizing the illustrative coffee shop example, the ratings interface 1310 and ratings verification system 1300 can be programmed to permit a first user who was only inside of the coffee shop for three minutes to input a rating only regarding the cleanliness of the coffee shop. The first user would not be permitted to input a rating regarding the quality of the coffee shop's coffee, food, employee helpfulness, or ambience, as the first user was not inside of the coffee shop long enough to likely have formed an opinion on these features that is genuine or useful. Alternatively, if a first user was only inside of the coffee shop for three minutes but his historic travel and location data indicates that the first user patronized the coffee shop on multiple prior occasions, the programming algorithm could be configured to permit the first user to input ratings regarding other features of the coffee shop based upon the correlative relationship between the length of a visit and number of prior visits. The precise relationship between the length of a particular visit and the number of prior visits, and how the correlation between those two operate to permit or prohibit the first user's ability to input ratings for particular features of the business, or what those business features are, are not the focus of the present embodiment, as many possible mathematical combinations can easily be envisioned that would be helpful to subsequent users; the present embodiment focuses on the advantages achieved by permitting such mathematical combinations and correlations to be calculated at all in assigning different measures of weight, credibility, or usefulness to a rating inputted by a first user.

Continuing with this illustrative example, as the length of time of the first user's visit increases, or the number of times the first user patronized the business increases, or some mathematical combination thereof, the first user is progressively permitted to input a rating on additional features or aspects of the business. For example, if the first user's visit exceeds fifteen minutes, the first user could be permitted to input a rating relating to the quality of the coffee, as fifteen minutes is long enough that a typical patron could have ordered a coffee, had it prepared and served, and begun drinking it. As the first user's visit exceeds thirty minutes, the first user could be permitted to input a rating relating to the quality of the food served, as thirty minutes is long enough that a typical patron could have been served food and eaten it. As the first user's visit exceeds one hour, the first user could be permitted to input a rating relating to the ambience of the coffee shop, as an hour could be deemed long enough for a typical customer to truly enjoy and “soak in” the ambience. Similar progressive ratings relating various features or aspects of a business can be easily envisioned for businesses other than coffee shops, involving other time thresholds appropriate for those businesses. As another illustrative example, a parallel algorithm can be envisioned for a steak restaurant in which a first user is permitted to rate the quality of food only after the first user has been inside the restaurant for thirty minutes, and only permitted to rate the quality of dessert only after the first user has been inside the restaurant for forty-five minutes. The particular length of time, the business features or aspects locked or unlocked over time, and the particular kinds of businesses or merchandise, goods, or services purchased, are not germane to the present embodiment. As another illustrative example, the processing unit 220 can display a greyed out or locked ratings display, such as a greyed out food rating which is displayed to a user who has not yet been verified to have spent enough time at the businesses awaiting review, which accordingly notifies the user that they may indeed be able to provide their rating or feedback (and may also notify the user of which criteria the user must complete before unlocking the capability to leave the rating or feedback); and thereafter, upon verification of the completed criteria, the processing unit 220 can accordingly unlock and notify the user that the user may now be able to provide their rating or feedback, such as displaying the option(s) to provide feedback in full color or unlocking and providing certain overlay displays that allow the user to select a rating or feedback or input their rating or feedback in a freeform textbox.

As both an alternative and cumulative addition to “locking” and “unlocking” the ability to input a rating associated with various features of aspects of a business, the ratings interface 1310 and ratings verification system 1300 can be configured or programmed to assign a different level of weight, credibility, or usefulness depending upon the length of the first user's visit to the business, the number of prior visits, the goals and achievements earned, or some combination thereof. Alternatively, or additionally, both can be used together in various combinations, for example, a first user's ability to input a rating may be locked or unlocked based upon some minimal time threshold and the number of prior visits, and any rating that the first user is permitted to input may also be assigned a different measure of weight, credibility, or usefulness as the length of time for that visit increases beyond that minimum time threshold. Alternatively, or additionally, the ability of a first user to input a rating for a particular feature or aspect of a business may also be based upon some combination or correlation involving not only the length of time for the visit and the number of prior visits, but also the goals and achievements earned by the first user.

In one embodiment, the processing unit 220 may track the length of time a first user remains within the business and subsequently offer an enticement or reward encouraging the first user to input a rating while on premises. As an illustrative example, if the first user is dining in a restaurant and the travel and location data indicate that he or she has been in the restaurant for one hour but has not yet inputted a review, the rating verification system could be programmed to offer a reward of, for example, free dessert, if they input a rating before they exit the premises. Alternatively, if travel and location data indicate that a user has just exited the premises of a business but has not yet inputted a rating, the ratings system 1300 could be configured or programmed to electronically transmit a reminder prompt to the first user to input a rating, accompanied by a reward or enticement such as a coupon or store credit.

Another disadvantage of existing ratings systems is that all ratings input by customers are counted equally regardless of the time of day, or day of the week, on which the customer patronized the business. A customer who patronized a business on a busy Saturday evening is likely to have had a different experience than one who patronized it on a slow Monday morning, yet existing ratings systems count both equally and provide no way to differentiate between the two. Thus, someone viewing the ratings and wondering whether to patronize the business on a busy Saturday night may have no way of knowing whether a particular rating was entered by a customer who visited on a slow Monday, and whose rating will be of little help, or by a customer who visited on a busy Saturday, and whose rating should be considered more relevant. This disadvantage is particularly egregious with businesses whose model changes over the course of a day or a week, such as a business that operates as a restaurant during the day but as a nightclub or karaoke bar at night; or a restaurant that serves very different types of food at breakfast, lunch, dinner, and “happy hour.”

As an illustrative example, the processing unit 220 can generate a happy hour (or other) icon, symbol, or identifier, a timer indicative of a countdown of remining time left of happy hour or time until happy hour begins, etc., which is displayed to the user as an overlay display that is associated with the listing of the business. For instance, the processing unit 220 can generate an icon of smiling face and/or a timer (which can be animated, glowing, or otherwise highlighted to garner attention) that is overlayed onto the business listing, as shown to the user. Hence, when searching, a user can quickly identify which business has an active and relevant happy hour or other benefit, in comparison to other related businesses. Additionally or alternatively, the processing unit 220 can generate a happy hour (or other) icon, symbol, or identifier for a business and display such on the map 112. Additionally or alternatively, the processing unit 220 can generate a separate display or map which can be a happy hour tracker, e.g., a listing of businesses presently having a happy hour and/or a map identifying such businesses. The happy hour tracker may grey out or outright not display businesses that are not presently offering a happy hour. The happy hour tracker can also display a timer indicating a countdown as to when a happy hour of a business begins or ends.

In one embodiment, the system 100 and its components—the ratings interface 1310, the ratings verification system 1300, and the display interface 1320—may be configured or programmed such that a first user is enabled to input different types or tiers of ratings, and the first user's ratings are assigned different measures of weight, credibility, or usefulness, based upon the time of day and/or the day of the week that the first user patronized the business.

As illustrative examples of the utility of this embodiment, it is well known that restaurants may serve different types or styles of food for breakfast, lunch, or dinner. Likewise some businesses may make available special dishes or drinks during different times of day, such as “happy hour.” It is also known that certain businesses are busier during certain times of day, or during certain days of the week, than at other times, such that a first user's customer service experience during a busier time may be very different than an experience with the same business at a less busy time.

The present embodiment contemplates adjusting the weight, credibility, or usefulness of an inputted rating by attaching data, extracted from the travel and location data of the first user who inputted the rating, relating to the time of day and/or day of the week, associated with the visit for which the rating was inputted. This data can be used by a subsequent user in one of four principal ways, although other ways may also be contemplated without departing from the scope and spirit of the invention.

First, a subsequent user may manually choose to view the time of day/day of week data when viewing the rating itself in order to mentally consider the context of the rating in deciding what measure of weight, credibility, or usefulness to assign to it.

Alternatively, or additionally, a second principal way that a subsequent user may use this data is that the ratings interface 1310 can be configured or programmed to enable a subsequent user contemplating patronizing a business at a particular time of day and/or day of the week may wish to choose to view only the ratings associated with that business for that particular time of day/day of the week. As an illustrative example, a subsequent user considering whether to patronize a popular restaurant at 6:00 on a Saturday night might have no interest in how other first users rated the restaurant on a Monday morning when the restaurant was likely significantly less busy and may have served a breakfast menu instead of a dinner menu. The processing unit 220 can display ratings or reviews of a given business based on the time at which the ratings or reviews were provided by previous users; thus, providing the most accurate and relevant information to the subsequent user. In other words, the processing unit 220 can hide ratings or reviews based on a dissimilar time window and/or reweight ratings or reviews within the complete pool of ratings or reviews based on dissimilar times at which previous users provided their user rating or feedback.

The third principal way in which this data may be used is that the ratings interface 1310 can be configured or programmed to automatically assign different measures of weight, credibility, or usefulness to a rating based upon the time of day/day of the week data. As an illustrative example, the ratings interface 1310 can be programmed to give less weight to a rating associated with a visit that occurred during a snowstorm when certain employees were absent.

As a fourth principal way, the ratings interface 1310 can be configured or programmed to combine this time of day/day of week data with other data relating to the first user's travel and location data, goals and achievements, and prior ratings, and assign different measures of weight, credibility, or usefulness accordingly. As an illustrative and not limiting example, a different measure of weight, credibility or usefulness may be assigned to the rating of a first user who patronized a particular business on many prior occasions during many different times of day and/or days of the week, with each visit lasting over an hour, and consistently inputted favorable ratings, then to the rating of a first user who only patronized a business on one occasion on an unusual time of day and/or day of week. An illustrative example of this might be a first user who attempted to visit a restaurant for the first time on Valentine's Day without a reservation and inputted a negative rating based upon his own lack of experience or poor judgment in failing to first make a reservation on day that is famously busy, rather than a genuine assessment of the restaurant. In that illustrative example, processing unit 220 may be configured to assign a lower level of weight, credibility, or usefulness to the rating by that particular first user than to a rating inputted by first users who patronized the same restaurant on many prior occasions and many different times of day and/or days of the week, and/or first users who have earned different goals and achievements.

Another disadvantage of existing ratings systems is that many do not come with tags enabling customers to link their ratings or reviews to particular features or aspects of a business or the merchandise, goods, or services that it may offer. In a “tag-less” ratings system, a customer may be permitted to enter only a single rating for the business without specifying what particular features of the business affected the rating, or even what particular merchandise, goods, or services the customer purchased. For example, a customer who patronized a particular business may have liked one feature of the business, such as the customer service, but may also have disliked another feature, such as the amount of inventory on hand. Without a tag system, the customer would only be permitted to enter a single rating for the business, and subsequent users would have no way to determine why the customer entered the rating that he or she did.

Some existing systems do include a tag system. But typically, those systems come with pre-determined categories of tags, and the customer must manually enter a rating for each tag. For example, a conventional system might offer a customer the ability to enter a rating for such tags as “customer service,” “cleanliness,” or “location.” But typical systems will offer the exact same tags for each and every business, even for businesses that offer very different merchandise, goods, or services. This limits the categories of available tags to only generic categories that could apply across many different types of businesses, and which cannot be tailored or individualized to particular businesses or categories of businesses.

Furthermore, customers who wish to enter a rating for each tag must do so manually, sometimes quite laboriously, entering a rating for each tag, one tag at a time, which requires the customer to take a significant amount of time entering multiple ratings for multiple tags, making the entire process of rating a business extremely cumbersome and inconvenient. Paradoxically, if the rating system offers more tags in an effort to make the tags more exact and therefore more useful, then the process of clicking through all of the tags becomes even more laborious and cumbersome. As a result, the majority of customers either completely ignore the tags or click on the first tag or two and then abandon the process, meaning that most tags have no entries, thus diminishing or even eliminating the value of having the tags in the first place.

The present embodiment overcomes these disadvantages by coupling the tag data with the first user's travel and location data. As mentioned hereinabove, the ratings inputted by various first users, along with any photos, videos, text comments, internet links, and other information that the first user inputs through the display interface 1320, are stored within the system 100. As also mentioned briefly hereinabove, the display interface 1320 may also be configured to enable a first user to enter tag data along with ratings. If desired, the algorithms programmed within the system 100, the ratings interface 1310, the ratings verification system 1300, and the display interface 1320, may be configured to offer tags in the conventional manner, including permitting ratings for such generic categories as “customer service” or “cleanliness” in much the same way as existing ratings systems.

But in one advantageous embodiment, those algorithms are programmed such that at least some of the tag data may be automatically generated based upon the first user's current and historical travel and location data and any prior ratings previously inputted by that first user. The display interface 1320 may be configured to display a combination of conventional generic tags along with some automatically generated tags as deemed commercially desirable, enabling first users to input ratings, and subsequent users to view them, for each of the various combinations of tags.

As an illustrative example of these automatically generated tags, suppose the travel and location data and prior ratings associated with a particular first user (let's call him “Joe” for this example) indicate that Joe frequently patronizes many different sushi restaurants and enjoys them, frequently rating them highly. Then suppose that Joe patronizes a new Japanese noodle restaurant for the first time and also rates it highly. Based on this data, the algorithms can be programmed to generate a tag for that business that requests Joe to input a rating for such tags as, for example, “would you recommend this noodle ship to other sushi lovers?” or “would other customers of sushi restaurant X enjoy this noodle shop,” or “was this noodle ship easy to get to from Business Y that you visited earlier today?” The display interface 1320 would enable Joe to input a rating for each of these automatically generated tags that is highly individualized to the particular business and Joe's travel and location history. Such data would likely be extremely useful to other subsequent users whose habits, tastes, and lifestyles mirror Joe's.

In other exemplary embodiment, the algorithms can be programmed to generate not only categories of tags for Joe to rate, but could also automatically generate answers or ratings for those tags based upon Joe's travel and location data and prior ratings without requiring any action by Joe. For example, when Joe's prior ratings indicate that he enjoys sushi restaurants and also rated the noodle shop highly, the algorithms can be programmed to generate such tags as, for example, even without any action by Joe: “highly rated by sushi lovers!” or “loved by Joe,” or “customers of business X also enjoy this restaurant,” or any other tag with similar commercial appeal to any subsequent user who views the ratings for that noodle restaurant. After a sufficient number of such tags have been generated for a sufficient number of businesses, the algorithms can be programmed in such a way that subsequent users could use the display interface 1320 to search for other businesses based on the tags stored with them, such as searching for all restaurants or businesses “highly rated by sushi lovers,” or “loved by Joe,” or according to any other tag stored within the system 100. This enables the system to accommodate tags individualized to particular businesses, without annoyingly requiring each first user to laboriously click through numerous tags one by one and manually enter a rating for each one.

Alternatively, or additionally, the travel and location data can be used in other ways to generate or enhance tag data. For example, the algorithms can be programmed to generate tags that describe their location or ease of access relative to landmarks or other businesses. As a simple illustrative example, the algorithms can be programmed to automatically generate tags identifying businesses that are located near airports, train stations, subway stops, city hall, popular parks or museums, concert venues, or any other landmark that a customer may wish to use for navigation or planning purposes. Such a tag may convey such information as “one block from the stadium,” or “a five-minute walk from the train station,” or any other commercially useful information. Subsequent users can utilize those tags to search for businesses that match the data, such as businesses near a concert venue where they are planning to attend a performance. As these tags can be automatically generated by the algorithms based on travel and location data, first users do not have to take the time to manually enter such tag data each time they input a rating for a business.

As another illustrative example, if the travel and location data for a large number of first users indicate that many first users frequently patronize a coffee shop after leaving a nearby museum, the algorithms can be programmed to generate a tag that states something along the lines of “popular with museum visitors,” or “a 3-minute walk from the museum,” or any other similar commercially valuable message. Within the system 100, the tag can be stored with the ratings for that business, as well as with the ratings for that museum, or both. Thereafter, subsequent users who view ratings either for the museum and/or for that business, will be provided with that tag on the display interface 1320. Subsequent users who are planning trips to the museum will see the tag for the coffee shop, which accomplishes the dual objectives of advertising the coffee shop as well as providing useful options for the subsequent user to plan a trip to the museum, without requiring first users to annoyingly manually input the tags themselves for each business.

In another advantageous embodiment, the algorithms programmed within the system 100, the ratings interface 1310, the ratings verification system 1300, and the display interface 1320, may be configured in such a way that each business can select the tags that it desires or considers appropriate to the business. In this embodiment, the business may select or generate various tags via the business interface 1330, further described hereinbelow. The tags generated by the business are electronically transmitted to the system 100, which stores them. Subsequently, when a first user wishes to enter a rating for that business, the tags selected by the business are displayed on the display interface 1320 for the first user to enter ratings. These tags and ratings are stored within the system 100 for future use by subsequent users. As an illustrative example, if a restaurant just invented a novel food dish and wishes to receive particularized feedback on that dish, it can input a tag relating to that dish into the system 100 through the business interface 1330. Thereafter, when a first user patronizes the restaurant and wishes to input a rating, the display interface 1320 will include a link or button requesting a rating for that dish. This accomplishes the dual objectives of indirectly advertising that dish to a first user who did not order it, and also prompting any first users who ate it to enter a rating for that individual dish that subsequent users can view. Subsequent users who view the ratings for that business will have displayed, on the display interface 1320, ratings for the tag associated with that dish (or a new dish), which accomplishes the dual objectives of subtly encouraging subsequent users to try it, and also providing information on specific dishes or other features relating to the business that are individualized to each business and thus well beyond the generic categories of tags offered by conventional ratings systems.

Once these tags are stored within the system 100, the display interface 1320 is configured or programmed to enable subsequent users to retrieve and view ratings corresponding to one or more of the tags. For example, the display interface 1320 can be configured with a button or link that, when selected, directs the retrieval only of ratings for which certain tags were inputted. As another example, the display interface 1320 can be configured with a button or link that, when selected, directs the retrieval only of ratings for which certain tags were inputted and the rating inputted for that particular tag exceeds a certain threshold rating. The present embodiment also contemplates that the display interface 1320 is configured or programmed to enable subsequent users to retrieve and view ratings corresponding to one or more of the tags in combination with any of the other criteria mentioned hereinabove, such as, for example, ratings above a certain threshold, ratings inputted by first users of a certain age, ratings having certain taste, habit, and lifestyle characteristics, or any other criteria mentioned hereinabove or that can be contemplated by those skilled in the art, in as many combinations with other criteria as the subsequent user desires.

The present embodiment also contemplates that, when a subsequent user utilizes the tags as a criterion for selecting which ratings to retrieve and view, the subsequent user can select or filter the tags in a manner identical to the criteria described hereinabove in relation to selecting and filtering the ratings themselves. As an illustrative example, the display interface 1320 can be configured or programmed such that a subsequent user can retrieve and view all businesses that received a high rating for a tag of “ambience,” “great view,” or “tasty steak,” or any other tag stored within the system 100. Thus, a subsequent user can search for all businesses that possess a certain feature or characteristic, or that sell a particular type of merchandise, goods, or services. As an additional illustrative example, the display interface 1320 can be configured or programmed such that a subsequent user can retrieve and view all businesses for which a particular combination of tags has been inputted and/or the ratings for those tags exceed a certain minimum threshold. Thus, for example, a subsequent user searching for all restaurants that might be a good spot for a romantic date could retrieve and view all businesses with tag ratings above four stars for the combination of “ambiance,” “great view,” “convenient parking,” “quiet,” “good music,” and “good food.” Similarly, a subsequent user searching for restaurants that serve a particular kind of food can retrieve and view all businesses with a tag for that kind of food. The present embodiment also contemplates that the display interface 1320 can be configured or programmed such that a subsequent user can utilize these tags as criteria in combination with any of the other criteria mentioned hereinabove, including overall ratings for a business or characteristics of a first user. As a single illustrative example, an especially picky subsequent user can search for all restaurants for which certain tags have been inputted, but only for businesses whose overall ratings exceed a certain minimum threshold of credibility, trustworthiness, and usefulness, but only inputted by first users whose tastes, habits, and lifestyles meet certain criteria, but only inputted by first users who spent a minimum of one hour in the business, but only inputted by first users who have previously patronized at least 5 businesses also patronized by the subsequent user, but only for first users between the ages of 20-29. This is but a single combination among many possible ones, and any or all tags, ratings, and other criteria described herein can be combined with any or all other tags, ratings, and other criteria described herein, as desired by any subsequent user, without departing from the scope and spirit of the invention.

One major disadvantage of existing ratings systems is that, in most cases, only a small minority of customers who patronize a particular business or purchase a particular product bother to input a rating for other customers to view. Consequently, the ratings associated with a business or product may represent the opinions of only a small fraction of customers who used it. One principal reason for this disadvantage is that, with existing ratings systems, there exists little to no incentive for customers to leave a rating; if anything, doing so may represent a bother as customers have to spend time inputting a rating that they could be using to do other things more important to them.

A second major disadvantage with existing rating systems is that, in many cases, there exists no accurate or reliable way to determine how many customers actually patronized a business or purchased a product, with the result that in most cases it is impossible to determine what fraction of customers bothered to leave a rating. In such cases, it is impossible to calculate how representative or unrepresentative the ratings even are without knowing what percentage of total customers inputted them. This renders existing ratings systems particularly unreliable.

In one embodiment, the system 100, ratings interface 1310, and ratings verification system 1300 are programmed with additional algorithms that provide certain rewards and incentives to first users who leave ratings for any business or its merchandise, goods, and services.

The additional algorithms operate by tracking when any first user patronizes any particular business when the first user's mobile device establishes a connection with the business' WAP, as previously described herein. When such a connection is established, the algorithm then tracks whether the first user inputs a rating or not associated with that business or its merchandise, goods, or services. The algorithms also track and store, within the system 100, the number of ratings each first user has ever inputted.

If the first user does leave a rating, the algorithms can be configured to provide the first user with a reward of some kind. This reward can take many forms, including a discount coupon or store credit that can be redeemed at the same or different business, cryptocurrency, cash, or one of many other potential rewards.

The reward system can also be programmed to be progressive, dispensing such rewards when the first user inputs a certain threshold number of ratings over time; and/or dispensing rewards of greater value as the first user inputs more ratings; or a combination of both. The rewards system can also be configured in “tier levels” or “achievement levels,” such that when the first user inputs a certain number of ratings beyond a threshold number, the first user is recognized as having reached a certain level of achievement entitling him or her to rewards of even greater value. As an illustrative example, the algorithms can be configured such that when a first user inputs 50 ratings, the value of the rewards dispensed thereafter take on greater value. When the first user inputs 100 ratings, the value of the rewards dispensed thereafter take on even greater value. This can continue progressively, on and on. These achievement levels can be allocated with many different thresholds, and with as many different levels as commercially useful.

On the other hand, if the algorithms determine that a first user patronized a business but did not input a rating either while present within the business or within a certain time after leaving the business, the algorithms can be programmed to electronically transmit a reminder prompt to the first user. The reminder prompt may also include an incentive to help induce the first user to input a rating. This incentive can be a simple reminder of the rewards that await if a rating is inputted, or alternatively it may be an additional reward of some kind, whether of the same type as the rewards given for ratings, or a different or complementary reward.

The rewards dispensed to first users can be of a kind useful to all first users, such as, for example, cash or cryptocurrency. Alternatively, the algorithms associated with dispensing rewards operate in conjunction with the other algorithms contained within the system 100, the ratings interface 1310, and the ratings verification system 1300, so that the rewards dispensed may be tailored to individual first users based upon their historical travel and location data and prior ratings. For example, the algorithms may be programmed to dispense discount coupons usable in businesses that the first user's travel and location data and prior ratings indicate that the first user frequents. Alternatively, the algorithms may be programmed to dispense discount coupons usable in businesses that the first user's travel and location data and prior ratings indicate that the first user has not patronized, but may wish to due to similarities to business that the first user did patronize and enjoy on prior occasions.

Notwithstanding these rewards and incentives, it is contemplated that on occasions some first users will not input a rating despite patronizing a business. In such cases, the system 100, the ratings interface 1310, and the ratings verification system 1300 regularly store data indicating every business that the first user patronized, as described hereinabove. This data can be easily compared against the ratings inputted by that first user to calculate the percentage of times the first user inputted a rating after patronizing any business. The algorithms associated with the rewards and incentive system can be configured or programmed to dispense additional rewards to first users who input ratings at a percentage that exceeds a certain threshold, thereby further incentivizing the first user to input ratings in the future.

Even when first users do not input ratings despite the incentives and rewards, the system 100, the ratings interface 1310, and the ratings verification system 1300 operate to store valuable data that can be used for various commercial purposes. As noted hereinabove, the system 100, the ratings interface 1310, and the ratings verification system 1300 regularly store data relating to each time any and/or all first users entered a business and connected to the business' WAP. The system 100, the ratings interface 1310, and the ratings verification system 1300 also store each and every rating inputted by any and/or all first users associated with that business. These sets of data can be easily compared to calculate the percentage of first users who patronized that business and inputted a rating, and the percentage of first users who patronized that business and did not input a rating. This percentage provides valuable insight into how accurate the inputted ratings may be, as inputted ratings are more likely to be accurate if left by larger percentages of customers.

These, and similar, calculations can be easily made for each and every business, and for each and every first user, or for any combination thereof. These calculations can be done to reveal such things as, for example: the first users who inputted the highest percentages of ratings relative to the total number of business patronized; the businesses for which the highest percentage of ratings were inputted by all first users; the dates and times during which the greatest percentages of first users were most likely to input ratings; the types of businesses, goods, or services for which the greatest percentages of ratings were inputted; whether any correlation exists between the length of time a first user patronizes a business and the likelihood that a rating will be inputted; whether the presence or absence of a rating correlates with the number of times a first user patronizes a business; whether a first user is more likely to input a rating after multiple visits to the business, and if so, how many; and other types of calculated data that may be commercially useful. Furthermore, by including tags and other stored data in these calculations as well as ratings, further calculations can be made to reveal such things as, for example: whether the presence or absence of certain tagged features associated with a business (such as highly-rated ambience, convenient parking, highly-rated customer service, or other tagged features) correlate to higher percentages of ratings inputted; which demographic groups of first users are the most or least likely to input a rating; and other types of calculated data that may be commercially useful.

Another disadvantage of existing ratings systems is that they typically do not permit the business being rated to interact with the system in a meaningful way or to retrieve the ratings given to them in a convenient or timely fashion, including while the customer is still on the premises. Further, existing ratings systems do not enable a business to know whether a particular customer is a repeat customer, or one who previously left a rating that was either favorable or negative, knowledge that might enable the business to improve the customer's experience, either because the customer is a valued repeat customer or because the customer was previously unsatisfied with the business.

The present embodiment overcomes these disadvantages by contemplating an alternative embodiment focused on permitting businesses to interact with ratings inputted by first users. In this alternative embodiment, the system 100 may also contain a business interface 1330 by which various business owners may be given some form of access to ratings, tags, and other data inputted by various first users who connected with the business' WAP.

The business interface 1330 may take any number of forms. The business interface 1330 may be an app, a website, and/or prompts to the business owner's device(s) to input various data concerning their business.

The business interface 1330 contains features, such as buttons or links, that a business owner can use to direct the ratings interface 1310 to retrieve any or all ratings or other data (such as text comments, photos, videos, internet and social media links, and tags) inputted into the system 100 by first users who previously connected with the business' WAP during a visit to the business. The system 100, ratings interface 1310, and business interface 1330 may be selectively configured or programmed to either provide a business owner with access to all of the ratings and other data, or they may be configured or programmed to limit the kinds of data that the business may retrieve. In certain situations, it may be desirable for commercial purposes, and for reasons of privacy, to prohibit business owners from accessing certain types of data stored within the system 100. In one embodiment, “role-based access control” (RBAC) is utilized to give different levels of permission to individual business, or to a group of businesses, to the ratings and other data stored within the system 100, although other approaches or technologies can be easily substituted to accomplish the same result without departing from the scope and spirit of the invention.

This business interface 1330 provides the business with a way of accessing the system 100 and directing the ratings interface 1310 to retrieve certain ratings and other data and then transmit the ratings and data to the business interface 1330 for display at the business. A business owner might be interested in such data as whether a particular first user has ever patronized the business previously, how many times, how long each visit lasted, what ratings they entered for the business or its merchandise, goods, or services, any other similar or relevant data which the business may use to customize or improve the first user's visit to the business. The business interface 1330 can be easily configured to enable the business owner to select any or all of these criteria, as well as other criteria not described herein that a business owner may wish to know. In response to these criteria, the ratings interface 1310 is programmed to direct the system 100 to retrieve the appropriate data and transmit it to the business interface 1330 for display.

Additionally, in certain appropriate situations, the ratings interface 1310 can be configured or programmed to retrieve certain ratings and other data from the system 100 and transmit it to the business interface 1330 even without a prompt from the business owner. As an illustrative and not limiting example, when a first user patronizes a particular business that the first user patronized previously, the ratings interface 1310 can be programmed to transmit an electronic message to the business interface 1330 that provides a notification to the business owner that a regular customer has entered the business, and may also be programmed to transmit personal data such as the first user's name, previous purchases, and ratings inputted on prior occasions, thus enabling the business owner to consider making personalized suggestions to the first user on what other merchandise, products, or services might be of interest, or to provide special discounts to the first user.

The system 100 and ratings interface 1310 may also be configured to electronically transmit a message to the business interface 1330 notifying the business whenever a negative or undesirable rating has been inputted by any first user. The processing unit 220 may reverify any negative or undesirable rating automatically upon receipt or at the request of the business owner. Therein, the business can strive to rectify any error or improve its merchandise, goods, or services. After reverification, the processing unit 220 may deprioritize the negative or undesirable rating such that it weighs less in an overall rating or is less likely to be seen by other users. The ratings interface 1310 can also be programmed to transmit not only the negative rating itself, but also additional information such as, for example, other ratings entered by the first user either for that business and/or for all other businesses, including similar business, as well as the first user's historical and present travel and location data, to provide contextual information that the business owner can try to use to better understand the reasons for the negative or undesirable ratings. By allowing the business not only to view any negative or undesirable ratings, but also to combine that with the travel and location data and prior ratings associated with the first user who entered the negative or undesirable rating, the business is provided with considerably more information than a traditional rating system which only provides the rating itself, without any other information about who may have given the rating and why the rating was negative.

When a business is given a negative or undesirable rating, the business interface 1330 may also comprise a data entry method that allows the business to respond to the rating, either by entering a text response, entering a photo of the business, or entering another kind of response, that is transmitted to the system 10 and stored along with the original negative rating. The ratings interface 1310 can be programmed to permit subsequent users who view the negative or undesirable response to also view the business' responsive data if they wish to do so. Whether any or all subsequent users are permitted to view the business' response depends on commercial decisions and can be adjusted by programming the algorithm within the ratings interface 1310 accordingly.

The business interface 1330 may also contain selectable options permitting a business owner to retrieve and use data stored within the system 100 to attract new customers. For example, even if a particular first user has never patronized a particular business on any previous occasion, the ratings interface 1310 may be programmed to determine, based on certain criteria relating to that first user's travel and location data, prior ratings, and other data, that the first user might be a good candidate to patronize the business in the future. Based on that determination, the ratings interface 1310 may be programmed to electronically transmit a message to the business interface 1330 suggesting that the business contact the first user directly and transmit, via text message, email, or other form of direct message, an invitation to patronize the business that could be accompanied by an advertisement, coupons, store credit, website link, or any other commercial enticement, to the first user in order to entice the first user into trying the business for the first time. This interaction may occur within the application itself, in an interface that is customized and only viewable by the intended user. The interaction can also occur on external mediums that include the aforementioned channels and mediums but are not limited to them. This can be done for any individual first user, or for all first users who meet the criteria. Alternatively, or additionally and cumulatively, the algorithm can be customized so that the business is only notified when the first user is located within a certain physical proximity to the business to maximize the chance that the first user will try out the business rather than ignore or forget about the invitation because, at the time it is received, the first user is nowhere near the business and going there would not be convenient. The algorithms described herein to determine which first users should receive such invitations may be developed by a particular individual business via the business interface 1330, or they may be developed and pre-programmed and stored within the ratings interface 1310 using any commercially viable criteria.

One embodiment of the invention will now be discussed by reference to a hypothetically typical sales transaction. In this exemplary embodiment, a first user patronizes a business and connects with the business' WAP. The first user purchases some merchandise, good(s), or service(s), and then inputs a rating for the business. The system 100 stores the rating, along with photos, videos, text comments, links, tags, and other data that the first user also inputs. In this embodiment, the ratings interface 1310 is programmed to electronically transmit notification of the rating to the business interface 1330 even without a request from the business owner. The system 100 transmits the rating to the business interface 1330, where the business owner can review the rating and other data and utilize it to improve its customer experience. If the business owner desires, the business may respond to any particular rating, whether positive or negative, by making the appropriate selections on the business interface 1330, which transmits the data to the system 100 and stores it along with the original rating. For example, the business owner may wish to express “thanks!” to a first user who inputted a positive rating, or to send a message along the lines of “sorry you didn't enjoy your experience, but here's a coupon for your next visit!” to a first user whose rating was negative. The ratings interface 1310 may be programmed to send a copy of the business owner's message to the first user who entered it, or some variation of it.

In this embodiment, thereafter, the ratings interface 1310 can also be programmed such that when the first user returns to the same business at a later date, the ratings interface 1310 sends an electronic notice to the business interface 1330 which notifies the business owner that a regular customer has returned and displays information relating to the first user, including the first user's name/age/other personal identifying information, the number of past visits, the dates on which they occurred, the amount of time spent within the business' premises, the ratings inputted by the first user for each experience, whether the first user redeemed any prior coupons or store credits, as well as the first user's historic travel and location data. The business owner can use this data to enhance the first user's experience and/or to electronically transmit to the first user invitations or advertisements designed to reward the first user for their loyalty.

In another alternative illustrative embodiment, the ecosystem server 200 allows a business to seek out potential new customers who have never before patronized the business. In this illustrative embodiment, the ratings interface 1310 can be programmed to retrieve and sift through data relating to various first users and identify, using various criteria, first users whose data fits or corresponds with the profile of someone who may be a good candidate to patronize a particular business. For example, the ratings interface 1310 can be programmed to search for first users who patronized similar or competing businesses and inputted a favorable rating. Alternatively, the ratings interface 1310 can be programmed to search for first users whose travel and location data are similar to known profiles of customers who frequently patronize the business. Alternatively, a business may wish to preferentially attract first users who are most likely to enter reviews, in which case the ratings interface 1310 can be programmed to search for first users who previously entered a minimum number, for example, 20 or 50 or 100, reviews of similar businesses on prior occasions. Any number of other criteria, including those known and regularly used for commercial marketing and advertising purposes, can be used. Once these first users are identified, their information can be transmitted to the business interface 1330 for the business to utilize for advertising purposes.

Once the data is received by the business interface 1330, the business may electronically transmit to the first user an invitation or advertisement promoting the business. The invitation or advertisement can include references or comparisons to other businesses that the first user is known to have patronized previously, with such words as, for example, “higher rated than Business X”; “one block away from Business Y”; “Like the sushi at Business Z? Then you'll love us!” Other similar words to that effect can be used as desired. This permits the invitation or advertisement to be individually tailored to that first user's prior travel and location patterns and prior experiences with other similar businesses.

The ratings interface 1310 can be programmed so that these tailored invitations or advertisements can be transmitted whenever the business owner desires, and as frequently or repetitively as the business owner desires. Alternatively, or additionally and cumulatively, the ratings interface 1310 can be programmed to transmit the invitations when the first user's travel and location data indicate that the first user either resides within, or currently is located in, close physical proximity to the business. By transmitting the invitation or advertisement when the first user is nearby, the business maximizes the probability that the first user may take advantage of the invitation as it is convenient at that moment for the first user to do so. Additionally, any such invitation or advertisement transmitted when the first user is near the business can be individually tailored to express a sentiment such as “Hungry? We're only one block away!” or “Need a drink? One block south and turn left!” or similar words to that effect. Tailored messages such as these, or other similar ones, can be made even more effective by programming the interface to send advertisements for food at times of day when the first user is most likely to be hungry, such as lunchtime. Alternatively, or additionally and cumulatively, advertisements can be sent at a time of day when the first user's historical travel and location data and prior ratings indicate that the first user commonly patronized similar business on other occasions. The present embodiment is not limited to any particular criteria or advertising message or invitation, but rather to the advantages achieved by informing businesses of the historical travel and location data, goals and achievements, and prior ratings associated with any particular first user or group of first users, thereby enabling advertising messages and invitations to be tailored in a way that prior ratings systems cannot achieve. Any number of other criteria, including those regularly used for commercial marketing and advertising purposes, can be used.

Alternatively, and additionally, the business interface 1330 can be configured or programmed to enable the business owner to invent goals and achievements for a first user to earn as a means of enticing the first user to either patronize the business, and/or input a rating for the business after patronizing it. These goals and achievements can be made available both to first users who have already previously patronized the business as well as to first users who have never patronized the business before. The business owner may input the selected goals and achievements, and the criteria to be used to earn them, into the business interface 1330, which electronically transmits them to the ratings interface 1310 which then may utilize them to identify appropriate first users.

As an illustrative and not limiting example, the business owner could offer a discount against future purchases to any first user who patronizes the business a certain number of times based upon the first user's travel and location data.

As another illustrative example, the business owner could offer enticements and/or rewards to first users to visit the business during certain times of day, such as happy hour. In that example, when the first user's travel and location data indicate that the first user indeed arrived at the business during happy hour, the ratings interface 1310 electronically transmits a coupon or store credit to the first user.

As another illustrative example, the ratings interface 1310 can be configured to offer rewards to first users whose visit to the business exceeds a certain time threshold, such as offering a coupon for free dessert to customers who spend at least an hour on the premises. In that example, when the first user's travel and location data indicate that the first user has indeed been on premises for at least one hour, the ratings interface 1310 can be programmed to electronically transmit a coupon or store credit to the first user, or the ratings interface 1310 can be programmed to notify the business via the business interface 1330 so that the business owner can provide the free dessert manually.

The interface can also be configured or programmed to entice first users into inputting a rating associated with the business. As an illustrative example, the ratings interface 1310 can be configured to electronically transmit a reward, such as a coupon or store credit or some other reward, to a first user who inputs a rating associated with the first user's visit to the business. The enticement can be offered and extended to all users who input a rating, and/or it can be tailored to target particular kinds of first users in a variety of ways. As an illustrative example of the latter, the ratings interface 1310 can be programmed to search for first users who reside, or are currently located, within a certain radius of the business who, based on their travel and location data and prior ratings, regularly patronize similar businesses, and an advertisement electronically transmitted to them offering a discount if they patronize the business within the next four hours. Alternatively, or additionally, the ratings interface 1310 can be programmed to search for first users who previously patronized the business and inputted a rating but have not returned to the business in a long time, such as a month, with an advertisement to the effect of, “We miss you! Come back today and receive 50% off your next purchase,” or some similar enticement or reward.

The present embodiment achieves the significant advantage that the cumulative data pertaining to the historical travel and location, goals and achievements earned, ratings inputted, and current location relating to any first user contains valuable insights into that first user's habits, tastes, and lifestyle. From this data can be gleaned information relating to the first user's travel patterns, shopping habits, taste in restaurants, recreational activities, and the like.

An alternative embodiment of the invention relates to configuring or programming the system 100 with AI algorithms designed to detect patterns in the habits, tastes, and lifestyle of any and all first users based upon the data. The AI processing unit 220 can make predictions regarding which additional businesses may suit those habits, tastes, and lifestyle. As an illustrative and not limiting example, if the data associated with a first user indicates that he or she frequents sushi restaurants regularly on weekends and has inputted consistently high ratings for sushi restaurants, the processing unit 220 could be programmed to recommend other sushi restaurants and transmit those recommendations electronically to the first user. These predictions and recommendations could be transmitted regularly, or the system 100 could be programmed to transmit them only on weekends when the first user is most likely to consider patronizing such a restaurant.

Alternatively, as well as additionally, the ratings interface 1310 can be configured with a feature that enables a first user to select the types of predictions and recommendations made to the first user. As an illustrative example, the ratings interface 1310 can be programmed to permit a first user to choose what kinds of recommendations to receive, such as, for example, recommendations for all similar businesses; recommendations only for similar business which have received average ratings higher than some selectable minimum threshold; recommendations only for similar businesses located within a certain radius of the first user; recommendations only for similar businesses patronized by other first users with selectable similarities in habit, taste, and lifestyle; recommendations only for similar businesses patronized by other first users of a certain age or gender or other demographic characteristic; recommendations based on a combination of some or all of these; or recommendations based on a variety of other criteria selectable by any first user.

These predictions and recommendations may be especially valuable for first users who are traveling, particularly to a city or locality the first user has never previously visited. When a first user visits a new city or locality, he or she is unlikely to be familiar with which businesses exist. It may also be true that when a first user travels, he or she may patronize different kinds of businesses than they do while at home. By way of a simple illustrative example, first users traveling to new localities are significantly more likely to seek out businesses that sell toiletries in “travel sized” portions permitted to be carried onto airplanes by the Transportation Security Administration. The AI algorithms programmed within the system 100 can be configured to make predictions and recommendations based not only upon the first user's overall habits, tastes, and lifestyle, but also based upon the first user's habits or prior patterns during previous travels to other cities or localities.

In one embodiment, the processing unit 220 may comprise AI algorithms for generating the ratings of businesses, the ratings of users, the ranking variables, the secondary ranking variables, curating the ratings in real time, and generating recommendations, such as travel recommendations.

AI travel recommendations can be generated by comparing first user's previous habits, pattern of life data generated within and by system 100. Cultural Event Matching: AI algorithms could analyze the user's interest in cultural activities and events, recommending local festivals, exhibitions, and performances that align with their tastes. Some travelers may like Coachella or music events and don't know that they are happening recently or soon—this is like recommending what is going on recently or locally and can be generated or pulled from input via the businesses or ecosystem server 200.

Friendly Language Places-Gringo Friendly: for travelers in countries where they do not speak the local language, the processing unit 200 could prioritize recommending businesses known for multilingual services or having menus and information available in the user's preferred language. For example, the processing unit 220 can prompt the user to input their preferred language and input an interest for local experiences or tourist friendly experiences. Thereafter, the processing unknit 220 can automatically identify the language of menus, and reprioritize ratings based on the user's preferences, interests, the language of the menus of certain businesses, and other similar users' ratings.

Weather Relevant Recommendations: the processing unit 220 can adjust recommendations based on current and forecasted weather conditions, suggesting indoor activities during rain or outdoor adventures on sunny days. It's going to rain so no patio or open air restaurants but places that may have an ambiance or atmosphere for certain weather.

Health and Safety Information: the processing unit 220 could inform travelers of local health advisories, safety ratings of neighborhoods, and recommend safe places to visit, especially important during health crises like pandemics. The processing unit 220 may generate a local Heat Map which displays an overlay of dangerous, unsafe, or risky areas the user shouldn't venture.

The processing unit 220 can also generate dietary specific tags. The tags could delve into dietary preferences or restrictions, suggesting restaurants that cater to specific needs like vegan, gluten-free, or halal options. The processing unit 220 can also recommend stays that match the user's budget, style preference (boutique, chains, hostels), and amenities (Wi-Fi® quality, breakfast included, gym facilities, etc.).

Live Like A Local Curator: the processing unit 220 can suggest “off the beaten path,” hole-in-the-wall, local-only experiences based on the user's adventurousness, recommending lesser-known spots that are highly rated by locals or match the user's interests in unique activities. The processing unit 220 can identify behavioral changes or new moods and suggest accordingly suggest new travel plans, businesses, or other points of interest, based on recent novelty, such as new music, new haircut as identified by purchase history or image analysis from user provided image data, a new workout routine as identified by fitness data, a relationship status change, and/or family status change as determined by purchase history, search history, and the like.

Itinerary Planner: the processing unit 220 can generate a list or experience(s) of what users did over the past X days in certain cities or countries or trips and produce a map to be produced on social media or shared in other mediums of the first user's experiences. The processing unit 220 may also offer real-time itinerary suggestions based on current location, time of day, and user energy levels (gauged by their activity), ensuring the traveler maximizes their experience without feeling overwhelmed.

In one embodiment, there is provided a ratings system for rating businesses, services, or merchandise, comprising: one or more memories storing computer executable instructions; and one or more processors that, when executing the computer executable instructions, are configured to: obtain user location data from a first user device of a first user; and obtain owner data of an owner business; a ratings interface permitting the first user to assign a user rating associated with the business, services and/or merchandise; and a ratings verification system which assigns varying measures of weight, credibility, or usefulness to the user rating in accordance with the first user's location data and travel data.

In one embodiment, there is provided a computer-implemented method comprising: obtaining user location data from a first user device of a first user; obtaining owner data of an owner business; enabling the first user to assign a user rating associated with the business, services and/or merchandise via a ratings interface; and assigning varying measures of weight, credibility, or usefulness to the user rating in accordance with the first user's location data and travel data.

In one embodiment, there is provided a ratings system for incentivizing a first user to input a rating associated with a businesses, services, or merchandise, comprising: one or more memories storing computer executable instructions; and one or more processors that, when executing the computer executable instructions, are configured to: obtain user location data and travel data from a first user device of a first user; obtain owner data of an owner business associated with a wireless access point (WAP); prompt the first user to input WAP data associated with the WAP; verify the WAP; generate a WAP verification status; generate a WAP database based at least in part on the owner data, the WAP data, and the WAP verification status; automatically connect subsequent user devices of subsequent users to the WAP; a ratings interface permitting the first user to assign a user rating associated with the business, services and/or merchandise; and a ratings rewards system which dispenses a commercially valuable reward to the first user in response to the first user assigning a user rating.

In a further embodiment, the ratings reward system further comprises: a prompt system that transmits an electronic notification to the first user when the first user establishes a connection with the business' WAP but does not assign a user rating associated with the business, services, and/or merchandise. In a further embodiment, the monetary value of the commercially valuable reward increases in accordance with the number of times the first user assigns a rating associated with any business, services, or merchandise. In a further embodiment, the ratings system further comprises: a memory which stores all ratings assigned by any and/or all first users, and data relating to each and every time any and/or all first users patronized a business, services, and/or merchandise; and an algorithm programmed to calculate, from the stored ratings and stored data, the percentage of times any and/or all first users assigned a rating associated with a business, services, and/or merchandise, in proportion to the number of times any and/or all first users patronized a business, services, and/or merchandise.

In another embodiment, there is provided a computer-implemented method comprising: obtaining user location data and travel data from a first user device of a first user; obtaining owner data of an owner business associated with a wireless access point (WAP); prompting the first user to input WAP data associated with the WAP; verifying the WAP; generating a WAP verification status; generating a WAP database based at least in part on the owner data, the WAP data, and the WAP verification status; automatically connecting subsequent user devices of subsequent users to the WAP; enabling the first user to assign a user rating associated with the business, services and/or merchandise via a ratings interface; incentivizing the first user to assign a rating associated with the business, services and/or merchandise by dispensing a commercially valuable reward in response to the first user assigning a rating.

In a further embodiment, the method further comprises prompting, via an electronic notification to the first user, when the first user establishes a connection with the business' WAP but does not assign a user rating associated with the business, services, and/or merchandise. In a further embodiment, the method further comprises increasing the monetary value of the commercially valuable reward in accordance with the number of times the first user assigns a rating associated with any business, services, or merchandise. In a further embodiment, the method further comprises storing in a memory all ratings assigned by any and/or all first users, and data relating to each and every time any and/or all first users patronized a business, services, and/or merchandise; and using the stored data to calculate the percentage of times any and/or all first users assigned a rating associated with a business, services, and/or merchandise, in proportion to the number of times any and/or all first users patronized a business, services, and/or merchandise.

The method steps described herein of the various methods can be performed in any desired order, and thereby the embodiments of the methods are not limited to what has been shown and described herein. Other embodiments, which differ from the aforementioned embodiments, may be recognized by those skilled in the art without departing from the disclosure and the claims.

Other embodiments, which differ from the aforementioned embodiments, may be recognized by those skilled in the art without departing from the disclosure and the claims.

1. A ratings system for rating businesses, services, or merchandise, comprising:
one or more memories storing computer executable instructions; and
one or more processors that, when executing the computer executable instructions, are configured to:
obtain user location data from a first user device of a first user; and
obtain owner data of an owner business;
a ratings interface permitting the first user to assign a user rating associated with the business, services and/or merchandise; and
a ratings verification system which assigns varying measures of weight, credibility, or usefulness to the user rating in accordance with the first user's location data and travel data.

2. The ratings system of claim 1, wherein the ratings verification system assigns varying measures of weight, credibility, or usefulness to the user rating in accordance with whether the first user established a connection to a WAP of the business prior to, or contemporaneously with, the time the first user assigned the rating.

3. The ratings system of claim 2, wherein the ratings verification system assigns varying measures of weight, credibility, or usefulness to the user rating in accordance with some criteria based upon an algorithmic relationship between the first user's location data and travel data and whether the first user established a connection to the WAP prior to, or contemporaneously with, the time the first user assigned the rating.

4. The ratings system of claim 3, wherein the ratings verification system assigns varying measures of weight, credibility, or usefulness to the user rating in accordance with some criteria based upon an algorithmic relationship between the first user's location data and travel data; whether the first user established a connection to the WAP prior to, or contemporaneously with, the time the first user assigned the rating; and how long the first user established a connection to the WAP.

5. The ratings system of claim 1, further comprising a memory for storing the first user's rating for possible review by future or subsequent users, along with the measure of weight, credibility, or usefulness associated with the rating.

6. The ratings system of claim 5, further comprising an interface providing selectable criteria with which subsequent users may select for review one or more of the various ratings stored within the memory by any and/or all first users accompanied by the measure of weight, credibility, or usefulness associated with the rating.

7. The ratings system of claim 6, further comprising one or more programmable algorithms within the ratings system that compare various aspects of location data and travel data of the first user who inputted one or more of the ratings, and various aspects of the location data and travel data of a subsequent user, and assigns varying measures of weight, credibility, or usefulness to the rating in accordance with the results of the comparison.

8. The ratings system of claim 7, wherein the interface further provides a means by which a subsequent user may select which of the algorithms and what kind of comparison to make between the various aspects of location data and travel data of the first user who inputted one or more of the ratings, and various aspects of the location data and travel data of a subsequent user.

9. The ratings system of claim 1, further comprising a business interface with which the business may establish a connection to the ratings system.

10. The ratings system of claim 9, further comprising selectable criteria located within the business interface with which the business may retrieve some and/or any and/or all of the ratings assigned by various first users.

11. A computer-implemented method comprising:
obtaining user location data from a first user device of a first user;
obtaining owner data of an owner business;
enabling the first user to assign a user rating associated with the business, services and/or merchandise via a ratings interface; and
assigning varying measures of weight, credibility, or usefulness to the user rating in accordance with the first user's location data and travel data.

12. The method of claim 11, wherein the varying measures of weight, credibility, or usefulness are assigned in accordance with whether the first user established a connection to a WAP of the business prior to, or contemporaneously with, the time the first user assigned the rating.

13. The method of claim 12, wherein the varying measures of weight, credibility, or usefulness are assigned in accordance with some criteria based upon an algorithmic relationship between the first user's location data and travel data and whether the first user established a connection to the WAP prior to, or contemporaneously with, the time the first user assigned the rating.

14. The method of claim 13, wherein the varying measures of weight, credibility, or usefulness are assigned in accordance with some criteria based upon an algorithmic relationship between the first user's location data and travel data; whether the first user established a connection to the WAP prior to, or contemporaneously with, the time the first user assigned the rating; and how long the first user established a connection to the WAP.

15. The method of claim 11, further comprising: storing the rating along with the measure of weight, credibility, or usefulness associated with it.

16. The method of claim 15, further comprising: providing selectable criteria with which subsequent users may select for review one or more of the various ratings stored accompanied by the measure of weight, credibility, or usefulness associated with the rating.

17. The method of claim 16, further comprising: comparing various aspects of the location data and travel data of one or more first users who assigned a rating, and various aspects of the location data and travel data of a subsequent user, and assigning a varying measure of weight, credibility, or usefulness to the rating in accordance with the results of the comparison.

18. The method of claim 17, further comprising: enabling a subsequent user to select what kind of comparison to make between the various aspects of location data and travel data of the first user who inputted one or more of the ratings, and various aspects of the location data and travel data of a subsequent user.

19. The ratings system of claim 11, further comprising: establishing a connection between the business and the ratings system.

20. The ratings system of claim 19, further comprising: providing selectable criteria with which the business may retrieve some and/or any and/or all of the ratings assigned by various first users for transmission to the business via the connection between the business and the ratings system.
